(19) United States
(12) Patent Application Publication
(10) Pub. No.: US 2025/0004678 A1
(43) Pub. Date: Jan. 2, 2025

(54) PRINTING APPARATUS

(71) Applicant: BROTHER KOGYO KABUSHIKI KAISHA, Nagoya (JP)

(72) Inventor: Yutaka URAKAWA, Nagoya (JP)

(21) Appl. No.: 18/756,090

(22) Filed: Jun. 27, 2024

(30) Foreign Application Priority Data
Jun. 30, 2023 (JP) 2023-108594

(51) Int. Cl. G06F 3/12; G06F 21/31

(52) U.S. Cl. CPC G06F 3/1236; G06F 21/31

(57) ABSTRACT

A printing apparatus includes a plurality of connection interfaces, a user interface, a printer, a memory, and a controller. The printing apparatus has at least one of a function of acquiring image data from an external device via any one of the plurality of connection interfaces, and of causing the printer to print the image data, a function of providing the external device with data via any one of the plurality of connection interfaces, and a function of acquiring an instruction from the external device via any one of the plurality of connection interfaces, and of performing a process according to the acquired instruction.

### REFERENCE TO RELATED APPLICATIONS

This application claims priority from Japanese Patent Application No. 2023-108594 filed on Jun. 30, 2023. The entire content of the priority application is incorporated herein by reference.

### BACKGROUND ART

A related are describes a printing apparatus that includes a plurality of interfaces including a connection interface.

The inventors have considered that a specific interface can be enabled or disabled, and in a state where the specific interface is disabled, a function of a printing apparatus having no relation with the disabled connection interface can be continuously used. Furthermore, the inventors have considered that there is room for improvement in the printing apparatus so that, when the connection interface is disabled as the specific interface, there is no possibility of unintentionally changing the setting to enabling which is a default setting.

The present disclosure has been made in view of the above problems, and an object thereof is to provide a printing apparatus that can continue to be used without any adverse effects even when a connection interface is disabled.

### SUMMARY

A printing apparatus includes a plurality of connection interfaces, a user interface, a printer, a memory, and a controller. The printing apparatus has at least one of a function of acquiring image data from an external device via any one of the plurality of connection interfaces, and of causing the printer to print the image data, a function of providing the external device with data via any one of the plurality of connection interfaces, and a function of acquiring an instruction from the external device via any one of the plurality of connection interfaces, and of performing a process according to the acquired instruction. The controller is configured to disable a connection interface among the plurality of connection interfaces, a first setting value stored in the memory indicating the connection interface is disabled, and perform an initialization process of initializing a setting value stored in the memory, according to an initialization instruction corresponding to an operation on the user interface. In a case where the controller receives a disabling instruction designating any one of the plurality of connection interfaces, a disabling process of storing, in the memory, the first setting value having a value indicating the designated connection interface is disabled. In a case where the first setting value indicating the connection interface is disabled is stored in the memory and the controller received the initialization instruction, perform a suggestion screen display process of causing the user interface to display a suggestion screen for suggesting that the first setting value stored in the memory is initialized to an initial value of the first setting value, the initial value of the first setting value being a value indicating the connection interface is enabled.

### BRIEF DESCRIPTION OF DRAWINGS

FIG. 1 is a block diagram of an MFP.

FIG. 2 is a timing chart illustrating a process executed between a controller and a browser.

FIG. 3 is a diagram illustrating a Web page displayed on the browser.

FIG. 4 is a diagram illustrating the Web page displayed on the browser.

FIG. 5 is a diagram illustrating the Web page displayed on the browser.

FIG. 6 is a flowchart illustrating a procedure of an administrator EWS setting process.

FIG. 7 is a diagram illustrating setting information.

FIG. 8 is a diagram illustrating display mode information.

FIGS. 9A to 9D show transition diagrams of a screen displayed on a user IF.

FIGS. 10A to 10G show transition diagrams of the screen displayed on the user IF.

FIG. 11 is a flowchart illustrating a procedure of an initialization process.

FIG. 12 is a flowchart illustrating the procedure of the initialization process.

FIGS. 13A to 13C show transition diagrams of the screen displayed on the user IF.

FIGS. 14A to 14G show transition diagrams of the screen displayed on the user IF.

### DESCRIPTION

### First Embodiment

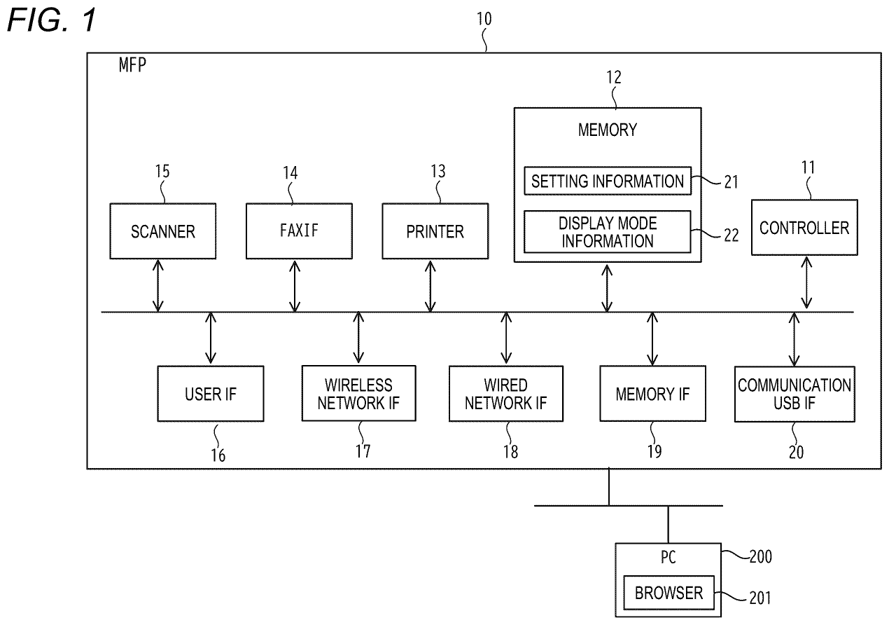

A printing apparatus according to the present embodiment will be described using a multifunction peripheral (MFP) as an example. An MFP 10 shown in FIG. 1 is connected to a network and is configured to communicate with a PC 200 via the network. The network is a LAN or the Internet. The MFP 10 may be connected to the network wirelessly or by wire.

The MFP 10 includes a controller 11, a memory 12, a printer 13, a FAX IF 14, a scanner 15, a user IF 16, a wireless network IF 17, a wired network IF 18, a memory IF 19, and a communication USB IF 20. These units are connected to a bus and configured to communicate with one another. “IF” is an abbreviation of an interface.

The user IF 16 is an interface interposed between a user who directly operates the MFP 10 and the controller 11. In the present embodiment, the user IF 16 includes a touch panel and an operation key which is a physical key. The printer 13 is configured to print an image on a recording medium such as a sheet or a disk. This may be expressed in other words as being able to perform printing, being able to execute a process of the printing, or the like. As a recording method of the printer 13, an ink jet method, an electrophotographic method, or the like can be adopted.

The FAX IF 14 is an interface for transmitting and receiving FAX data to and from a transmission destination device, using a FAX protocol. The MFP 10 has a FAX transmission function of transmitting, to the transmission destination device via the FAX IF 14, scan data generated by reading performed by the scanner 15, transmission data transmitted from the PC 200, and recording data read from a USB memory via the memory IF 19. The MFP 10 has a FAX reception function of printing, on the sheet by the printer 13, the FAX data received via the FAX IF 14, transmitting the FAX data to another PC 200 via the network IFs 17 and 18, and writing the FAX data to the USB memory via the memory IF 19. All of the FAX data, the scan data, the transmission data, and the recording data may be referred to as image data.

The scanner 15 is configured to read a document and generate the scan data. The MFP 10 has a copy function of causing the printer 13 to print the scan data generated via the scanner 15, a scan transmission function of transmitting the scan data to, for example, a PC or a server (not shown) via the network IFs 17 and 18, or the communication USB IF 20, and a scan direct function of writing the scan data to the USB memory via the memory IF 19. The scan transmission function and the scan direct function may be collectively referred to as a scan function. The printing performed by the printer 13 and the generation of the scan data performed by the scanner 15 are examples of an image forming process. A process involving the printing and the generation of the scan data is also an example of the image forming process. That is, processes of the copy function, the scan function, the FAX transmission function, and the FAX reception function are examples of the image forming process. Further, processes of outputting such as printing, transmission, and writing in the functions may be collectively referred to as an output process.

The memory IF 19 is an interface for inputting and outputting data in accordance with a universal serial bus (USB) standard. The data input and output may be a concept including communication. The memory IF 19 includes a port through which the USB memory can be attached and detached. The USB standard is not particularly limited, and USB 2.0 standard, USB 3.0 standard, or the like can be adopted. The USB memory may be any portable type memory configured to be attached to and detached from the MFP 10 via the port. For example, the USB memory may be a USB-connectable HDD. For example, the USB memory may be a memory card configured to communicate with the MFP 10, via a card reader connected to the port via a USB. Further, the memory IF 19 may include, as a port, a card slot into which the memory card is configured to be inserted and removed. The memory card may be, for example, an SD card.

The wireless network IF 17 is a network IF configured to connect the MFP 10 to the network wirelessly, for example, via a wireless LAN. The wired network IF 18 is a network IF configured to connect the MFP 10 to the network by wire, for example, a wired LAN.

Hereinafter, both the wireless network IF 17 and the wired network IF 18 may be referred to as the network IFs 17 and 18. The communication USB IF 20 is configured to perform data communication with an external device via a USB cable in accordance with the USB standard.

The controller 11 includes a CPU, an application specific integrated circuit (ASIC), and the like. The memory 12 is a built-in memory built into the MFP 10, and may be formed by combining RAM, ROM, SSD, HDD, and the like. A buffer provided in the controller 11 and used when various programs are executed may also be regarded as a part of the memory 12.

The MFP 10 may include a storage medium readable by the controller 11 in addition to the memory 12. The storage medium readable by the controller 11 is a non-transitory medium. The non-transitory medium also includes a recording medium such as a CD-ROM or a DVD-ROM in addition to the above-described examples. The non-transitory medium is also a tangible medium. On the other hand, an electric signal carrying a program downloaded from a server or the like on the Internet is a computer-readable signal medium, which is a kind of computer-readable medium, but is not included in the non-transitory computer-readable storage medium.

The memory 12 is configured to store firmware as a program executable by the controller 11. The present embodiment mainly shows a process of the controller 11 according to a command written in the program. That is, processes such as “determination”, “judgment”, “calculation”, “determination”, “specification”, “acquisition”, “reception”, and “control” to be described below represent processes of the controller 11. The term “acquisition” is used as a concept indicating that a request is not essential. That is, a process of receiving data without a request from the controller 11 is also included in a concept indicating that “the controller 11 acquires data”. Further, the term “data” in the present specification is represented by a controller-readable bit string. Furthermore, data having substantially the same meaning and different formats are treated as the same data. The same applies to “information” in the present specification.

In the present embodiment, a target to be operated and selected by a user or an administrator is described as an “option”, a “button”, an “icon”, an “object”, or the like for convenience, but other words may be used instead.

The controller 11 also functions as an embedded web server (also referred to as a Web server (EWS)) configured to cause the PC 200 to display a predetermined Web page by executing the firmware. The controller 11 cis configured to cause a later-described browser 201 of the PC 200 to display the Web page by transmitting, to the PC 200, Web page data for displaying the Web page.

The controller 11 is configured to refer to setting information 21 stored in the memory 12, and enable an IF to which a setting value “enable”, which will be described later, is set, and disable the IF to which a setting value “disable” is set. Details will be described later.

Next, a configuration of the PC 200 will be described. The PC 200 includes a communication IF, a memory, a controller, a display, and a user IF which are not shown. The memory of the PC 200 stores an OS and the browser 201. The browser 201 is an abbreviation of a browser program. The controller of the PC 200 is configured to operate in accordance with the browser 201 to cause the display to display the Web page corresponding to the Web page data transmitted from the MFP 10. In the present embodiment, the Web page that the controller 11 causes the browser 201 of the PC 200 to display as the web server, and the PC 200 configured to display this Web page are also examples of the user IF. A terminal is not limited to the PC 200 and may be a portable terminal such as a smartphone as long as the terminal is a device that can perform wireless communication with the MFP 10 via a network.

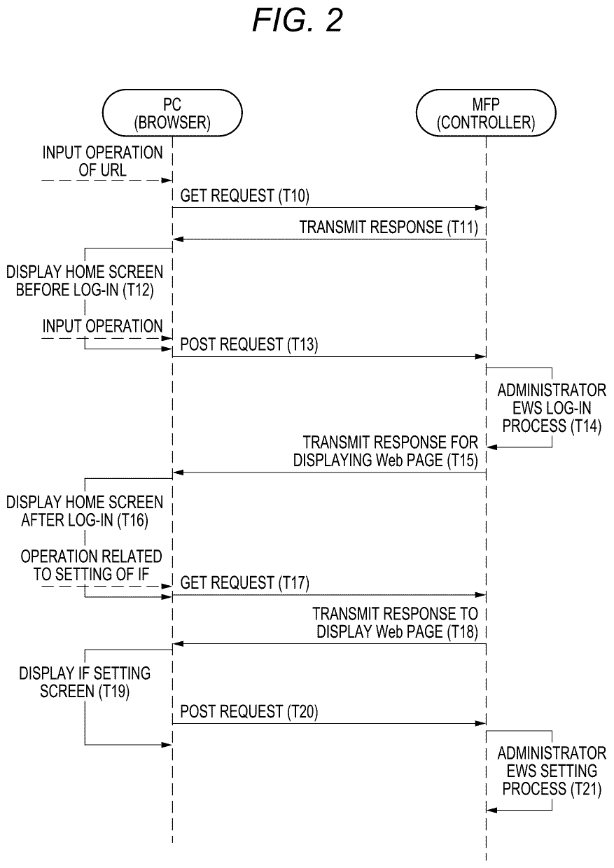

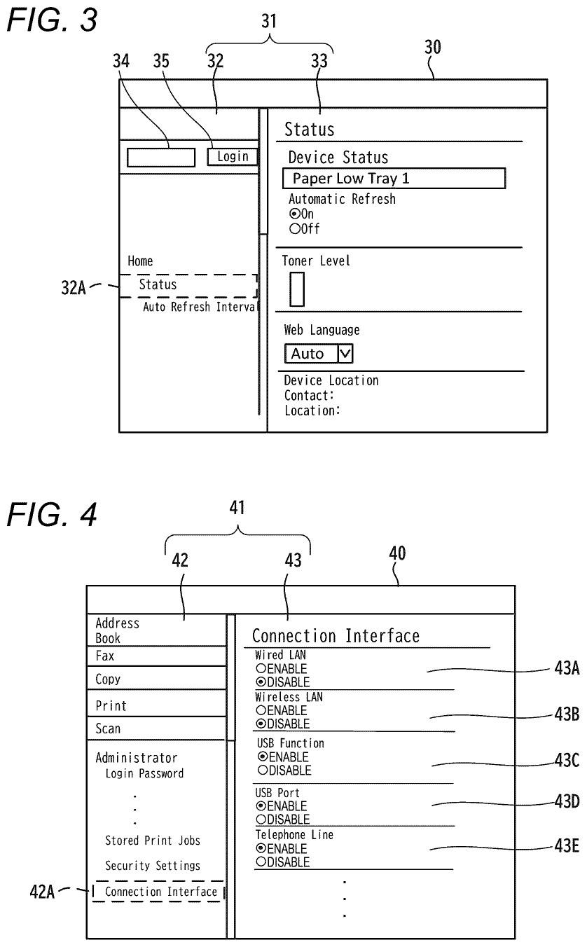

Next, a procedure of a process of setting enabling and disabling of various interfaces in the MFP 10 will be described with reference to FIG. 2. In the present embodiment, the setting of the enabling and disabling of various IFs of the MFP 10 can be performed using the function of the Web server of the controller 11. That is, the controller 11 is configured to display Web pages shown in FIGS. 3 and 4, which will be described later, by supplying the Web page data to the browser 201, and is configured to receive operations for designating the enabling or disabling of various interfaces from operations on this Web page.

The user operates the PC 200 to input a URL for specifying the Web server of the MFP 10 to the browser 201. The browser 201 is configured to transmit a GET request for HTTPS communication based on the input URL, at a timing T10. In a case where the controller 11 receives the GET request from the browser 201, the controller 11 transmits an HTTPS response corresponding to the GET request.

A response returned at timing T11 includes the Web page data for displaying a home screen before log-in shown in FIG. 3. In a case where the browser 201 of the PC 200 receives the Web page data, the browser 201 of the PC 200, which is a requesting source device, causes the display to display the home screen before the log-in using the Web page data on at timing T12. The browser 201 is configured to execute a remote process in which, by receiving the Web page data, the browser 201 receive an instruction corresponding to an operation via the Web page, and transmit the received instruction to the MFP via the wireless network IF 17. In the present embodiment, a screen displayed by the browser 201 based on the Web page data from the MFP 10 is an example of an operation screen of the remote process.

The home screen 30 shown in FIG. 3 includes a page display field 31 including a menu 32 and a content display portion 33. The menu 32 displays an option for receiving an operation of instructing content to be displayed on the content display portion 33. The home screen 30 may include a URL display field for displaying a URL of a registration site above the page display field 31. FIG. 3 shows an example of the home screen based on the Web page data included in the response returned at timing T11. FIG. 3 shows a state where an option “status” 32A of the menu 32 is selected on the home screen 30 before the log-in. The option “status” 32A is a lower option of the option “home” and is also an option corresponding to a current state of the MFP 10 and a display of a setting content on the content display portion 33. The content display portion 33 includes a field for designating, as a status of the MFP 10, an enabling state of “automatic refresh” that is an “on” state and a disabling state of “automatic refresh” that is an “off” state, a field for indicating a remaining amount of a toner, a field for receiving a setting for a language to be displayed on the Web page, and the like.

In a case where a selection operation is performed on any option of the menu 32, the browser 201 transmits, to the controller 11, the GET request for requesting the Web page data corresponding to the selected option. A transmission timing of the GET request for requesting the Web page data corresponding to the selected option may be a timing at which the selection operation is performed via the home screen, and is not limited to timing T17 in FIG. 2. The controller 11 is configured to transmit, to the PC 200, the response including the Web page data, in accordance with the requested request. Accordingly, the browser 201 is configured to cause the content display portion 33 to display an operation screen, which is a Web page, corresponding to a selected item. Instead of a configuration in which the controller 11 transmits the Web page data as a response to the browser 201, a configuration may be used in which the controller 11 transmits only data indicating a screen to be displayed on the content display portion 33 to the browser 201, and the browser 201 changes a display on the content display portion 33 using the data.

In a case where the user inputs an administrator password, which is administrator information, in an administrator information input field 34 displayed on the menu 32 for the home screen 30 and operates a log-in icon 35, the browser 201 transmits a POST request including the administrator password to the controller 11 at timing T13. Upon receiving the POST request including the administrator password, the controller 11 performs an administrator EWS log-in process at timing T14.

In the administrator EWS log-in process executed at timing T14, in a case where the controller 11 determines that the POST request includes the administrator password, the controller 11 permits the administrator to log in. Specifically, the controller 11 is configured to determine whether the administrator password included in the POST request completely matches an administrator registration password that has been registered in the MFP 10. In addition, in a case where the administrator password and the administrator registration password partially match, the controller 11 may permit the log-in to the MFP 10. In a case where a person other than the administrator logs in, the controller 11 does not permit the log-in.

In a case where the controller 11 permits the administrator to log in, the controller 11 generates a response when the administrator successfully logs in, and transmits the response to the MFP 10, at timing T15 in FIG. 2. The response includes a Web page data (not shown) for displaying the home screen after the log-in of the administrator, which is a Web page. A configuration of the home screen after the administrator logs in is a combination of the content display portion 33 in FIG. 3 and the menu 42 in FIG. 4. In a case where the browser 201 receives the response from the MFP 10, the browser 201 causes the user IF 16 to display the home screen after the log-in of the administrator, which is the Web page, at timing T16. Even in the home screen after the administrator logs in, in a case where the selection operation is performed on any option of the menu, the browser 201 transmits, to the controller 11, the GET request for requesting the Web page data corresponding to the selected option. Upon receiving the GET request, the controller 11 transmits, to the PC 200, the response including the Web page data, in response to the GET request.

Here, a case in which an option “connection interface” 42A that is subordinate to an option “administrator” of the menu 42 is selected on the home screen after the log-in of the administrator, will be described. In a case where the browser 201 transmits the GET request at timing T17, the controller 11 supplies the PC 200 with the Web page data for displaying an IF setting screen 40 at timing T18. FIG. 4 shows the IF setting screen 40 that is an operation screen (Web page) displayed by the browser 201 at timing T19. The operation screen is displayed, in a case where the option “connection interface” 42A is selected. Only in a case where the administrator successfully logs in, the controller 11 transmits, to the browser 201, the Web page data for displaying the home screen after the log-in of the administrator, which includes the menu 42, at timing T15. That is, in a case where the administrator does not log in successfully, the controller 11 does not transmit, to the browser 201, the Web page data for displaying the IF setting screen 40 based on the selection operation of the option “connection interface” 42A in the menu 42 in the browser 201, at timing T14.

A content display portion 43 in the IF setting screen 40 includes items 43A, 43B, 43C, and 43D for receiving operations of enabling and disabling a “wired LAN”, a “wireless LAN”, a “USB function”, a “USB port”, and a “telephone line” which are connection IF in the MFP 10. The item “wired LAN” 43A is an item configured to receive an instruction to enable or disable the wired network IF 18. The item “wireless LAN” 43B is an item configured to receive an instruction to enable or disable the wireless network IF 17. The item “USB function” 43C is an item configured to receive an instruction to enable or disable the communication USB IF 20. The item “USB port” 43D is an item configured to receive an instruction to enable or disable the memory IF 19. The item “telephone line” 43E is an item configured to receive an instruction to enable or disable the FAX IF 14.

In a case where the administrator selects a radio button “enable” in each of the items 43A to 43E in the content display portion 43 in the IF setting screen 40, an enable setting of the IF is designated, a disable setting of the IF is designated when a radio button “disable” is checked.

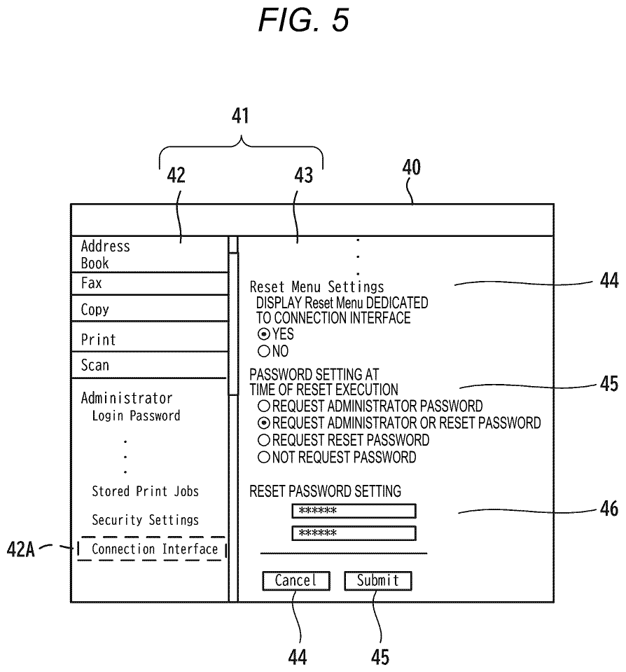

The IF setting screen 40 continues. In a case where the administrator performs an operation of scrolling the IF setting screen 40, the browser 201 scrolls the IF setting screen 40 and changes a display content of the content display portion 43 to an image shown in FIG. 5. The IF setting screen 40 shown in FIG. 5 is a screen for receiving designation of a display mode of a screen suggesting that the setting information 21 indicating disabling of the connection IF is initialized (reset) in the content display portion 43. The screen suggesting that the setting information 21 indicating the disabling of the connection IF is initialized is a screen indicating that the setting value “disable” indicating to the administrator that the connection IF is disabled is initialized in a case where the radio button “disable” corresponding to any connection IF is checked on the IF setting screen 40 shown in FIG. 4, and an initialization process to be described below is performed. Details of the screen suggesting that the setting information 21 indicating the disabling of the connection IF is initialized will be described later.

The IF setting screen 40 shown in FIG. 5 includes an operation object “reset menu settings” 44, an operation object “password setting at time of reset execution” 45, and an operation object “reset password setting” 46. The operation object “reset menu settings” 44 is an object configured to receive a designation as to whether to display a reset menu dedicated to the connection IF in a case of receiving an execution instruction of the initialization process as a display mode of the screen suggesting that the setting information 21 indicating the disabling of the connection IF is initialized. In a case where a radio button “yes” of the operation object “reset menu settings” 44 is checked, a screen, which is an initialization instruction receiving screen 84 to be described later, including the object configured to receive the execution instruction of the initialization process dedicated to the connection IF is displayed on the user IF 16 during the initialization process. On the other hand, in a case where a radio button “no” of the operation object “reset menu settings” 44 is checked, a screen that does not include the object configured to receive the execution instruction of the initialization process dedicated to the connection IF is displayed on the user IF 16 during the initialization process.

The operation object “password setting at time of reset execution” 45 is an object configured to receive an instruction as to whether to request an input of a password during the initialization process. In a case where a radio button “request administrator password” is checked in the operation object “password setting at time of reset execution” 45, a mode of requesting the input of the administrator password is designated in the initialization process. In a case where a radio button “request administrator or reset password” is checked in the operation object “password setting at time of reset execution” 45, a mode of requesting an input of either the administrator password or the reset password is designated in the initialization process. In a case where a radio button “request reset password” is checked in the operation object “password setting at time of reset execution” 45, a mode of requesting an input of the reset password is designated in the initialization process. In a case where a radio button “not request password” is checked in the operation object “password setting at time of reset execution” 45, a mode is designated in which neither the input of the administrator password nor the input of the reset password is requested in the initialization process.

The administrator password is a password necessary for performing, on the MFP 10, an operation that is permitted only to the administrator and that is not permitted to users other than the administrator. The reset password is a password used for initializing the setting value stored in the memory 12, and is not a password necessary for performing an operation that is not permitted to the users other than the administrator.

The operation object “reset password setting” 46 is an object configured to receive registration of the reset password that is input in a case where the input of the reset password is designated, during the initialization process. Specifically, in a case where the radio button “request administrator or reset password” or “reset password setting” is checked in the operation object “password setting at time of reset execution” 45, the operation object “reset password setting” 46 receive the input operation of the reset password. In the present embodiment, the operation objects “reset menu settings” 44, “password setting at time of reset execution” 45, and “reset password setting” 46 are examples of an operation object configured to receive an instruction as to which mode is used for displaying a suggestion screen. The controller 11 is configured to generate Web page data reflecting a content of the setting information 21 stored in the memory 12, and is configured to transmit the Web page data, in timing T18. Therefore, at timing T19, the browser 201 displays the IF setting screen 40 in which a check state of the radio button in each of the items 43A to 43D is a state where the content of the setting information 21 is reflected.

In this example, it is assumed that the administrator checks the radio buttons “disable” for the operation objects “wired LAN” 43A and “wireless LAN” 43B in the content display portion 43 and checks the radio button “enable” for the other operation objects. It is also assumed that, in the content display portion 43 shown in FIG. 5, the radio button “yes” of the operation object “reset menu settings” is checked, the radio button “request administrator or reset password” of the operation object “password setting at time of reset execution” is checked, the reset password is input to the operation object “reset password setting”, and an approval button 45 is operated.

At timing T20, the browser 201 transmits, to the MFP 10, a POST request including information indicating an IF for which the disabling is designated and information designating the display mode of the screen suggesting that the setting information 21 indicating the disabling of the connection IF is initialized on the IF setting screen 40. At timing T20, the browser 201 may designate the disabling only for the connection IF for which a check state of the radio button is changed from “enable” to “disable”, among the IFs for which the “disable” is checked on the IF setting screen 40. In a case where a cancel button 44 is operated on the IF setting screen 40, the browser 201 returns a check state of the content display portion 43 to a state where the content of the setting information 21 is reflected.

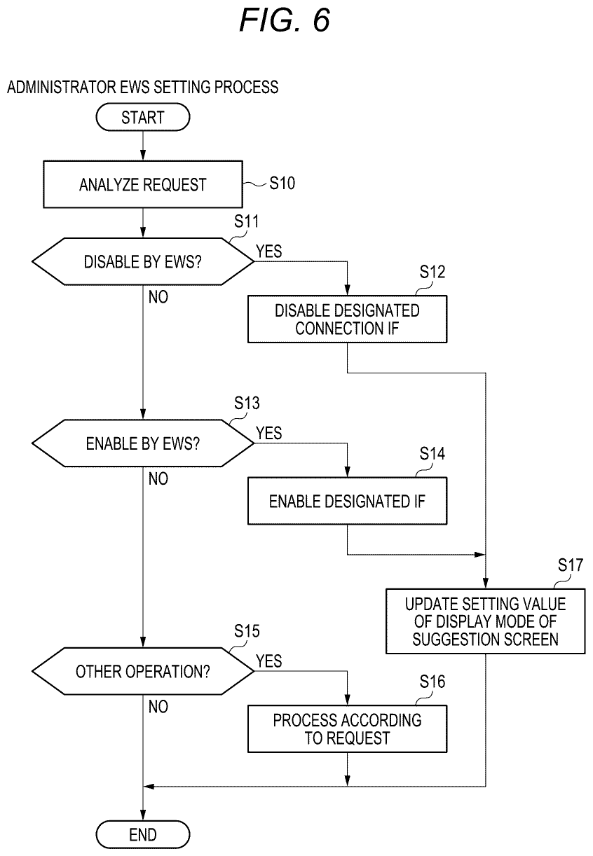

In a case where the controller 11 receives the GET request or the POST request from the browser 201, the controller 11 executes an administrator EWS setting process at timing T21. FIG. 6 is a flowchart illustrating details of the administrator EWS setting process executed in timing T21.

In step S10, the controller 11 analyzes a content of the requests received from the browser 201. First, a case where the browser 201 receives an instruction to disable any one of connection IFs on the IF setting screen 40 will be described. In a case where the POST request indicates an instruction to disable at least one of the connection IFs (step S11: YES), the controller 11 proceeds to step S12.

In step S12, the controller 11 disables the connection IF designated by the POST request. The controller 11 makes the connection IF inaccessible, that is, in a disabling state, by stopping a power supply to an IC chip that configures the connection IF for which the disabling is designated, for example. Accordingly, the controller 11 cannot communicate with the connection IF. In addition, even in a case where the controller 11 receives an interruption process from the connection IF when the connection IF is set to be disabled, the controller 11 may disable the communication with the connection IF by ignoring the interruption process. For example, in a case where the wired network IF 18 as the connection IF is disabled, the communication between the MFP 10 and the PC 200 via the wired network becomes impossible.

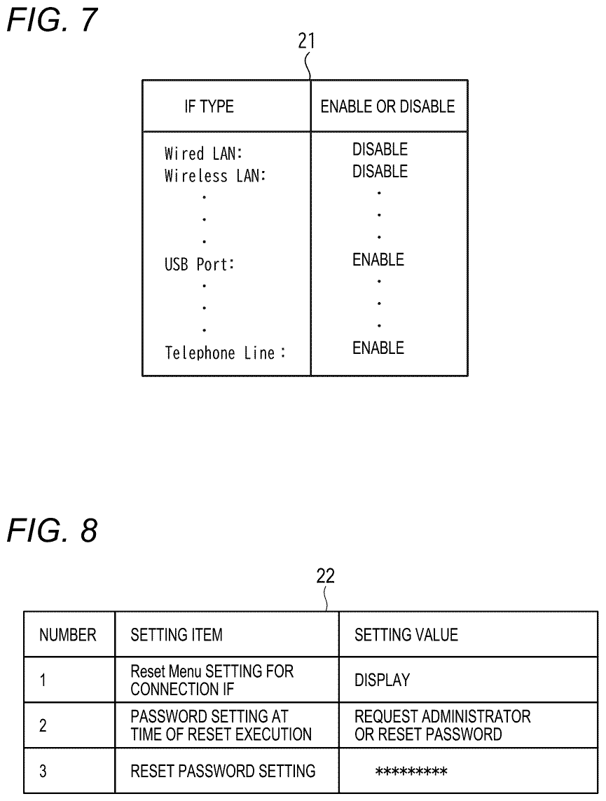

In step S12, the controller 11 changes, from the setting value “enable” indicating the enabling to the setting value “disable” indicating the disabling, a setting value corresponding to the connection IF for which the disabling is designated, among setting values stored in the setting information 21. The setting information 21 is information for registering various functions executable by the MFP 10 and setting states of enabling and disabling of various IFs. FIG. 7 shows a part of the setting information 21 stored in the memory 12. In the setting information 21, an item “IF type” in which a type of each of the connection IFs is registered and an item “enable or disable” in which a setting value indicating enabling and disabling by EWS is registered, are associated with each other. In the item “enable or disable”, in a case where the setting value is “enable”, the setting value indicates that the connection IF specified by a corresponding item “IF type” is in a enabling state by the EWS, and in a case where the setting value is “disable”, the setting value indicates that the connection IF specified by the corresponding item “IF type” is in a disabling state by the EWS. In a factory shipment state of the MFP 10, all setting values indicating the “enable”, that is, the enabling state, are registered in the item “IF type” of the setting information 21. In addition, in the setting information 21, setting values indicating that some items “IF type” are set to the “disable”, that is, in the disabling state, may be registered in the factory shipment state. In the present embodiment, the setting value indicating the enabling or the disabling stored in the setting information 21 is an example of a first setting value.

In step S17, the controller 11 updates display mode information 22 stored in the memory 12 using the information indicating the display mode of the screen suggesting that the setting information 21 indicating the disabling of the connection IF in the POST request is initialized. As shown in FIG. 8, the display mode information 22 includes “number”, “setting item”, and “setting value”. In the display mode information 22, a setting item “reset menu setting for connection IF” corresponding to the item “reset menu settings” on the IF setting screen 40 is registered in a number “1”. In the case where information indicating that “yes” is checked in the option of the item “reset menu settings” is included in the IF setting screen 40 in the POST request, the controller 11 registers a setting value “display” in the setting item “reset menu setting for connection IF” in the display mode information 22. On the other hand, in the case where information indicating that “no” is checked in the option of the item “reset menu settings” is included in the IF setting screen 40 in the POST request, the controller 11 registers a setting value “not display” in the display mode information 22.

In the display mode information 22, a setting item “password setting at time of reset execution” corresponding to the item “password setting at time of reset execution” on the IF setting screen 40 is registered in a setting number “2”. In a case where the POST request includes information indicating that any one of check boxes of the “request administrator password”, the “request administrator or reset password”, the “request reset password”, and the “not request password” in the item “password setting at time of reset execution” on the IF setting screen 40 is checked, the controller 11 registers a setting value corresponding to the item checked in the POST request in the setting item “password setting at time of reset execution” in display correspondence information 25.

In the display mode information 22, a “reset password” registered in the item “reset password setting” on the IF setting screen 40 is registered in a setting number “3”. In a case where the reset password is in the POST request, the controller 11 registers the reset password in the POST request in the setting item “reset password setting” in the display correspondence information 25. In the present embodiment, setting values of the items “number”, “setting item”, and “setting value” in the display mode information 22 are examples of a second setting value.

Next, a case where the browser 201 receives another operation via the content display portion 43 will be described. When the POST request indicates an instruction to enable any one of the connection IFs (step S13: YES), the controller 11 proceeds to step S14. In step S14, the controller 11 enables the connection IF designated by the POST request. For example, the controller 11 restores the stopped power supply to the IC chip configuring the connection IF designated by the POST request, thereby enabling the connection IF. In addition, in a case where the controller 11 is set to ignore the interruption process from the connection IF and disable the connection IF, the controller 11 may enable the communication with the connection IF by canceling the ignoring of the interruption process. In step S17, the controller 11 updates the display mode information 22 stored in the memory 12, based on the information in the POST request.

Even after processing in step S17, the browser 201 remains displaying the IF setting screen 40, and thus the administrator can receive an operation via the menu 42 and an operation via the content display portion 43. Next, a case where the administrator performs another operation via the screen displayed on the browser 201 will be described. In this case, the browser 201 of the PC 200 transmits the GET request or the POST request corresponding to the operated option to the MFP 10. The controller 11 determines that the operation is an operation other than the enabling and disabling of the connection IF in step S15 (step S15: YES), and executes a process according to a content of a request in step S16. For example, in a case where the GET request from the browser 201 requests that a content of the screen be updated to a new Web page, the controller 11 transmits, to the PC 200, the Web page data for displaying the requested Web page. With the IF setting screen 40 shown in FIG. 4 displayed on the browser 201, in a case where the controller 11 includes information including an instruction to hide the IF setting screen 40 in the POST request (step S15: YES), the controller 11 proceeds to step S16, and may transmit, to the MPF 10, Web page data including a screen in which the IF setting screen 40 is hidden.

Next, a case where the other operation is a log-out operation will be described. The browser 201 is also configured to receive an operation on a log-out button on the screen (not shown) displayed by the browser 201. Upon receiving the operation on the log-out button (not shown), the browser 201 transmits, to the MFP 10, a POST request including information indicating log-out. In a case where the controller 11 of the MFP 10 receives the POST request including the information indicating the log-out (step S15: YES), the controller 11 proceeds to step S16 and executes an administrator EWS log-out process in response to a log-out instruction included in the POST request.

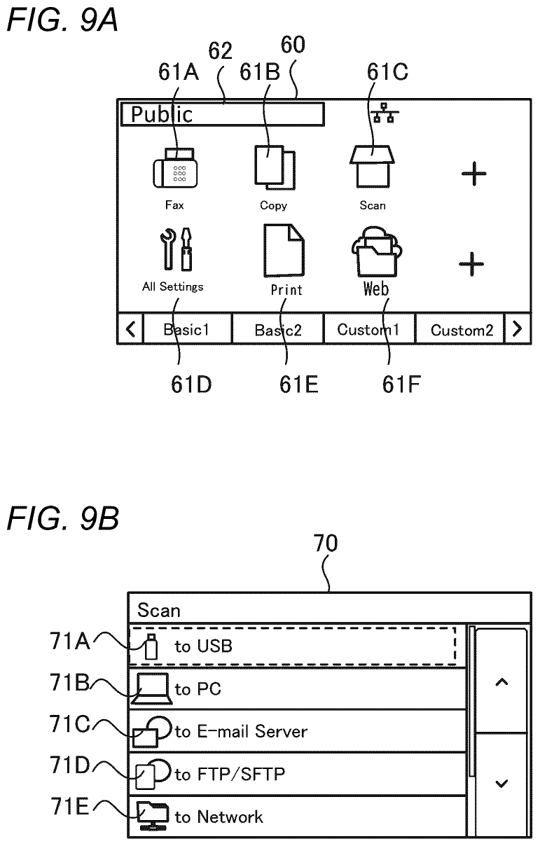

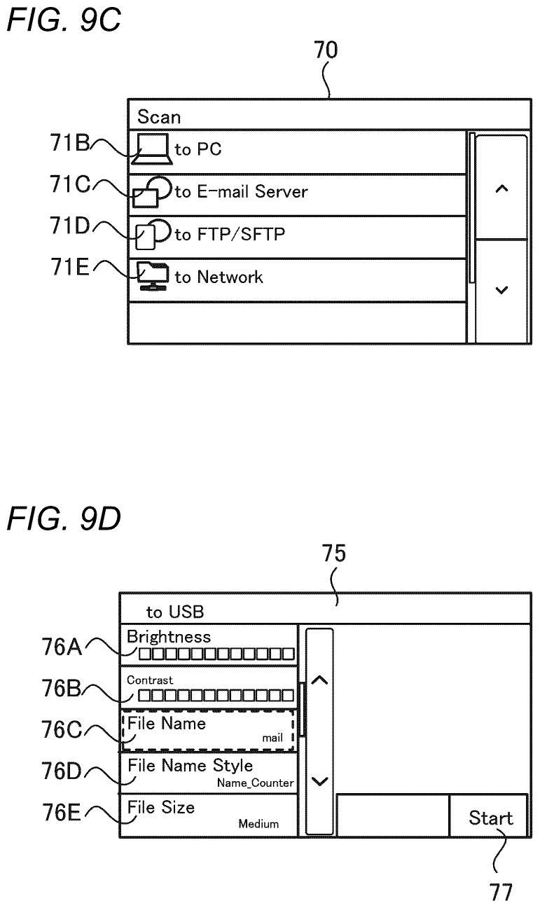

Next, a process of changing a screen displayed on the user IF 16 by the controller 11 when the user operates the user IF 16 of the MFP 10 will be described with reference to FIGS. 9A to 9D.

In a case where the MFP 10 is in a standby state, a standby screen 60 shown in FIG. 9A is displayed on the user IF 16. For example, the MFP 10 enters the standby state, in a case where an activation process at the time of activation ends. For example, in a case where an operation such as printing or scanning is finished, the MFP 10 enters the standby state. In the activation process at the time of activation of the MFP 10, as described above, the controller 11 prevents the connection IF from functioning by not supplying the power supply on the IF for which the setting value “disable” is set in the setting information 21. The standby screen 60 shown in FIG. 9A includes operation icons 61A to 61F corresponding to the respective functions of the MFP 10.

In a case where the operation icon “fax” 61A is operated, the MFP 10 execute a process of printing, on the sheet by the printer 13, FAX data received via the FAX IF 14, as a process associated with the FAX reception function. In a case where the operation icon “fax” 61A is operated, the MFP 10 execute, as a process associated with the FAX transmission function, an output process of transmitting, to the transmission destination device via the FAX IF 14, the scan data read by the scanner 15 or the recording data read from the USB memory connected via the memory IF 19. The FAX reception function includes a case in which the received image data is immediately printed and a case in which an instruction stored in the memory 12 is received from the user through a screen displayed by the operation of the operation icon “fax” 61A to perform the print. In the present embodiment, as a process associated with the FAX reception function, an output process of printing out the FAX data received via the FAX IF 14 on the sheet by the printer 13 is an example of a function of acquiring image data from an external device via any one of a plurality of connection interfaces and causing the printer to print the image data. As the process associated with the FAX transmission function, a process of transmitting the scan data read by the scanner 15 or the recording data read from the USB memory connected to the memory IF 19 to the transmission destination device via the FAX IF 14 is an example of a function of providing data to the external device via any one of the plurality of connection interfaces.

In a case where the operation icon “copy” 61B is operated, the MFP 10 execute an output process of printing out the scan data acquired via the scanner 15 by the printer 13, as a process associated with the copy function.

In a case where the operation icon “scan” 61C is operated, the MFP 10 execute, as a process associated with the scan transmission function (an example of the scan function), an output process of transmitting the scan data acquired via the scanner 15 to the PC 200 as the external device, a server (not illustrated), or the like via the network IFs 17 and 18 and the communication USB IF 20. In a case where the operation icon “scan” 61C is operated, the MFP 10 execute a process of writing the scan data acquired via the scanner 15 to the USB memory connected via the memory IF 19, as a process associated with the scan direct function, which is an example of the scan function. In the present embodiment, as the process associated with the scan function, the output process of transmitting the scan data acquired via the scanner 15 to the PC 200, the server (not shown), or the like via the network IFs 17 and 18 and the communication USB IF 20 and the process of writing the scan data acquired via the scanner 15 to the USB memory connected via the memory IF 19, are examples of the function of providing the data to the external device via any one of the plurality of connection interfaces. In a case where the operation icon “scan” 61C is operated, an output destination selection screen 70 shown in FIG. 9B to be described later can be displayed on the user IF 16.

The operation icon “all settings” 61D is an icon corresponding to a setting process for various settings of the MFP 10.

In a case where the operation icon “print” 61E is operated, the MFP 10 execute an output process of causing the printer 13 to print out the image data stored in the memory 12 or the USB memory attached to the memory IF 19, as a process associated with the printing function. The memory 12 or the USB memory attached to the memory IF 19 may be configured to store the image data received from the PC 200 via the communication USB IF 20. The memory 12 or the USB memory attached to the memory IF 19 may be configured to store the image data received from the PC 200, a smartphone, or the like via the network IFs 17 and 18. Of course, the MFP 10 can print the image data acquired via the network IFs 17 and 18 and the communication USB IF 20 without receiving the operation of the operation icon “print” 61E.

In the present embodiment, as the process associated with the printing function, an output process of causing the printer 13 to print out the image data received via the communication USB IF 20 and an output process of causing the printer 13 to print the image data received via the communication USB IF 20 and stored in the memory 12 or the USB memory are examples of a function of receiving the image data from the external device by USB communication and printing the image data. As the process associated with the printing function, an output process of causing the printer 13 to print out the image data received via the network IFs 17 and 18 and an output process of causing the printer 13 to print the image data received via the communication USB IF 20 and stored in the memory 12 or the USB memory, are examples of a function of receiving the image data from the external device through LAN communication and printing the image data.

In a case where the operation icon “web” 61F is operated, the MFP 10 execute an output process of printing out image data downloaded from the server by the printer 13 via the network IFs 17 and 18, as a process associated with a function of using a Web service. In a case where the operation icon “web” 61F is operated, the MFP 10 execute an output process of receiving the image data from the PC 200 or the like via the network IFs 17 and 18 and printing out the image data by the printer 13, as the process associated with the function of using the Web service. In a case where the operation icon “web” 61F is operated, the MFP 10 execute an output process of uploading and outputting, to the server, the scan data acquired via the scanner 15, via the network IFs 17 and 18 as the process associated with the function using the Web service. In a case where the operation icon “web” 61F is operated, the MFP 10 execute an output process of outputting the scan data acquired via the scanner 15 to a mail server, an FTP server, an SFTP server, or a shared server (not shown), via the wireless network IF 17, as the process associated with the function using the Web service. In the present embodiment, as the function using the Web service, an output process of printing out the image data downloaded from the server via the network IFs 17 and 18 by the printer 13 and an output process of receiving the image data from the PC 200 or the like via the network IFs 17 and 18 and printing out the image data by the printer 13 are examples of the function of receiving the image data from the external device by the LAN communication and printing the image data. As the function using the Web service, the process of uploading the scan data to the server via the network IFs 17 and 18 and the output process of transmitting the scan data to the mail server, the FTP server, the SFTP server, or the shared server via the wireless network IF 17 are examples of a function of providing the data to the external device via any one of the plurality of connection interfaces.

In addition to the above-described operation icons, the standby screen 60 may include icons corresponding to functions of accessing an application service via the network IFs 17 and 18 and of using the application service. The function using the application service also include an output process of downloading image data instructed from the application service and printing out the image data by the printer 13, and an output process of uploading and outputting scan data to the application service.

Further, the standby screen 60 may include an operation icon corresponding to a function of receiving instruction data from the external device via any one of the plurality of connection IFs, for example, any one of the wireless network IF 17, the wired network IF 18, and the USB IF 19, and executing a process according to the received instruction data, for example, a process according to the instruction data for executing, for example, printing of predetermined data and setting of a setting value. In addition, the standby screen 60 may include an operation icon corresponding to a function of reading instruction data from the memory attached to the memory IF 19 and executing a process according to the read instruction data, for example, a process according to the instruction data for executing, for example, printing of predetermined data and setting of a setting value. In the present embodiment, accompanying the function of executing the process according to the instruction data, receiving the instruction data from the external device via any one of the network IFs 17 and 18, and the USB IF 19 and processing according to the received instruction data, and reading the instruction data from the memory attached to the memory IF 19 and processing according to the read instruction data are examples of a function of acquiring an instruction from the external device via any one of the plurality of connection interfaces, and executing a process according to the acquired instruction.

The log-in icon 62 is an icon indicating a current log-in state in the MFP 10. In the standby screen 60 shown in FIG. 9A, the log-in icon 62 displays a text indicating a state in which no person logs in the MFP 10, that is, “public”.

A screen transition when the operation icon “scan” 61C is operated on the standby screen 60 shown in FIG. 9A will be described. First, a case will be described in which the setting values of all the IF types including the IF type “wireless LAN” in the setting information 21 stored in the memory 12 are “enable” indicating the enabling. In a case where the controller 11 detects that the operation icon “scan” 61C is operated, the controller 11 changes the screen displayed on the user IF 16 to the output destination selection screen 70 shown in FIG. 9B. The output destination selection screen 70 includes options 71A to 71E for designating an output destination of the scan data in the scan function.

In the output destination selection screen 70, the option “to USB” 71A is an icon corresponding to an output process of outputting the scan data to the attached USB memory via the communication USB IF 20 which is the connection IF that is enabled, which is a process associated with the scan function. The option “to PC” 71B is an icon corresponding to an output process of outputting the scan data to the PC 200 which is the external device, via the network IFs 17 and 18 which are the connection IFs that are enabled, which is a process associated with the scan function. The option “to E-mail server” 71C is an icon corresponding to an output process of outputting the scan data to the mail server (not shown) via the wireless network IF 17 which is the connection IF that is enabled, which is a process associated with the scan function. The option “to FTP/SFTTP” 71D is an icon corresponding to an output process of transmitting the scan data to the FTP server or the SFTP server via the wireless network IF 17 which is the connection IF that is enabled, which is a process associated with the scan function. The option “to network” 76D is an icon corresponding to an output process of transmitting the scan data to the shared server on a network via the network IFs 17 and 18 which are the connection IFs that are enabled, which is a process associated with the scan function. In the present embodiment, each of the options 71A to 71E in the output destination selection screen 70 is an example of an “operation object corresponding to execution of process involving communication via connection interface”.

In a case where the controller 11 detects that the option “to USB” 71A is selected on the output destination selection screen 70, the controller 11 causes the user IF 16 to display a setting screen 75 shown in FIG. 9D. The setting screen 75 includes icons 76A to 76E corresponding to setting items designated by a process “scan to USB” associated with the scan function. Icons in the setting screen 75 differ depending on a function selected on the standby screen 60. For example, in a case where the function relates to the copy function, setting values of setting items “output size”, “quality”, and “color” and setting values of setting items “number of copies” and “duplex printing” are used. For example, in a case where the “function” relates to the scan function, setting values of setting items “storage destination”, “read size”, “output size”, “quality”, and “color”, a setting value of a setting item “scaling”, and the like are used. Here, since “scan to USB” is a process associated with the scan function, setting values of items “read size”, “scan size”, “file size” which is a type of “output size”, “brightness” which is a type of “quality”, and “contrast” which indicates strength of contrast, are used. Further, in the “scan to USB”, setting values of items “file name” indicating a stored file name, a “file name style” indicating a style of a file name, and a “skip blank page” indicating whether a blank sheet is excluded from a scan data storage target are used.

In the present embodiment, each of the options 71A to 71E in the output destination selection screen 70 is an example of the “operation object corresponding to execution of process involving communication via connection interface”. In a case where the controller 11 detects that a start button 77 is operated on the setting screen 75, the controller 11 starts a process corresponding to a currently selected function (in this example, scan to USB).

Next, a case where a setting value of an IF type “USB function” is “disable” indicating the disabling in the setting information 21 stored in the memory 12 will be described. In this example, the screen transition when the operation icon “scan” 61C is operated on the standby screen 60 shown in FIG. 9A will also be described. In a case where the controller 11 detects that the operation icon “scan” 61C is operated, the controller 11 changes the screen displayed on the user IF 16 to the output destination selection screen 70 shown in FIG. 9C. The controller 11 refers to the setting information 21 shown in FIG. 7 stored in the memory 12, and hides, on the output destination selection screen 70, the option corresponding to the IF type for which a setting value of the item “enable or disable” is “disable” in the setting information 21. In the present embodiment, among options, options for which corresponding connection IFs are all disabled are hidden from the output destination selection screen 70. In this example, since the setting value of the IF type “USB function” indicates the disabling, that is, the setting value “disable” of the communication USB IF 20 is registered in the setting information 21, the option “to USB” 71A is hidden on the output destination selection screen 70 shown in FIG. 9C, and the other options 71B to 71E are displayed.

On the output destination selection screen 70, an option for which any one of the corresponding connection IFs is disabled may be hidden from the output destination selection screen 70.

In a case where the option 71A is hidden on the output destination selection screen 70, the controller 11 cannot display a setting screen corresponding to the function “scan to USB” described above. Therefore, since the user cannot operate the start button displayed on the setting screen, the user cannot cause the MFP 10 to execute the process “scan to USB” associated with the scan function.

In the setting information 21 stored in the memory 12, in a case where the setting value of the “USB function” is “disable”, for example, the option “to USB” 71A is displayed on the output destination selection screen 70, but an operation on the option “to USB” 71A may not be received. Even in this case, since the user cannot operate the start button displayed on the setting screen, the user cannot cause the MFP 10 to execute the process corresponding to the currently selected function.

Next, in the setting information 21 stored in the memory 12, a case where the setting values of the IF types “wired LAN” and “wireless LAN” are “disable”, that is, the wireless network IF 17 and the wired network IF 18 are disabled will be described. In this example, the screen transition when the operation icon “scan” 61C is operated on the standby screen 60 shown in FIG. 9A will also be described. In a case where the controller 11 detects that the operation icon “scan” 61C is operated, the controller 11 changes the screen displayed on the user IF 16 to the output destination selection screen 70 described above. In this example, in the setting information 21, since the setting values of the IF types “wired LAN” and “wireless LAN” indicate the disabling, the options “to E-mail server” 71C, “to FTP/SFTP” 71D, and “to network” 71E are hidden on the output destination selection screen 70, and the other options 71A and 71B are displayed. In this case, the output destination selection screen 70 also displays the options “to E-mail server” 71C, “to FTP/SFTP” 71D, and “to network” 71E, but may not receive a selection operation.

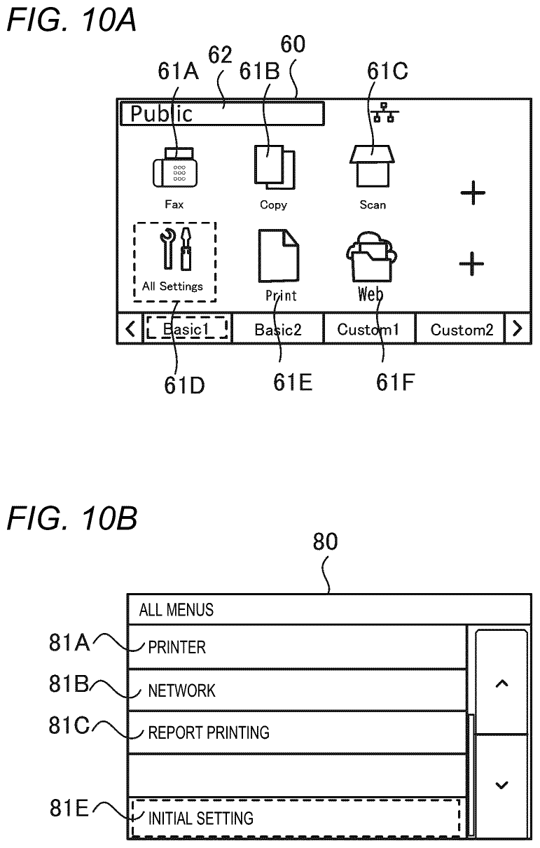

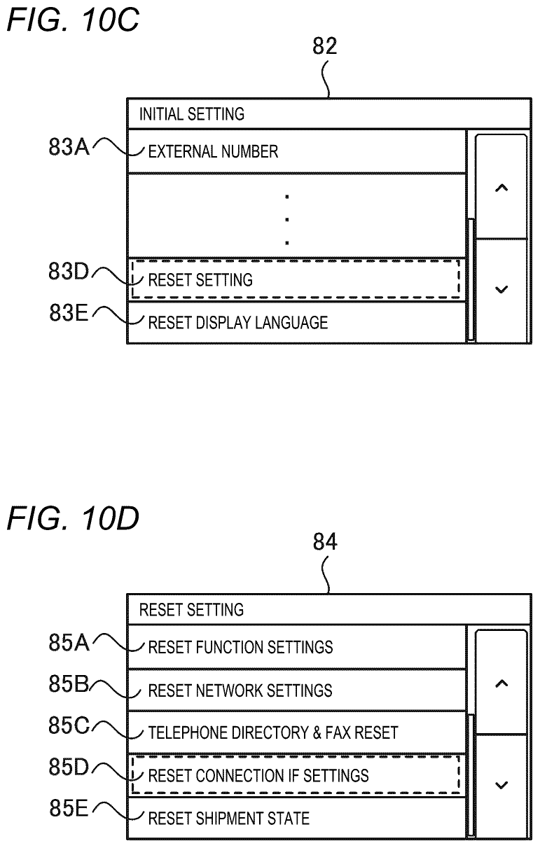

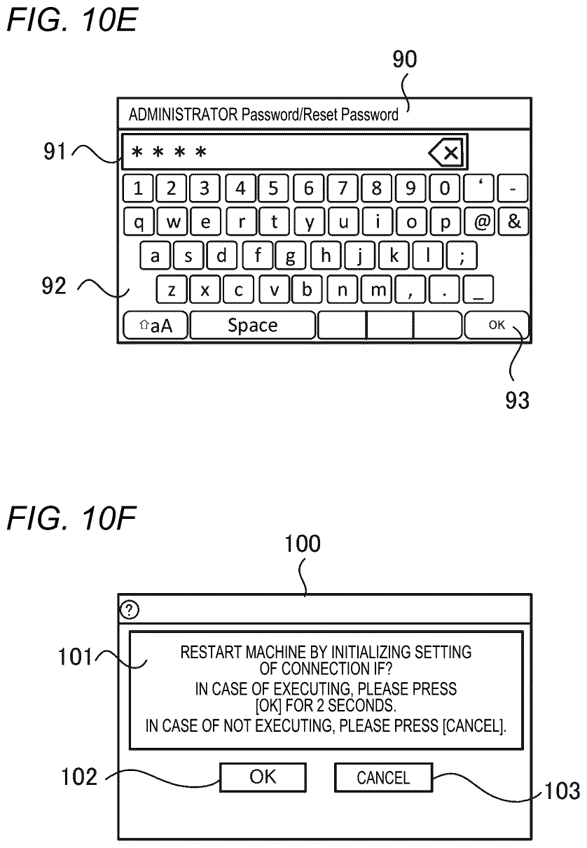

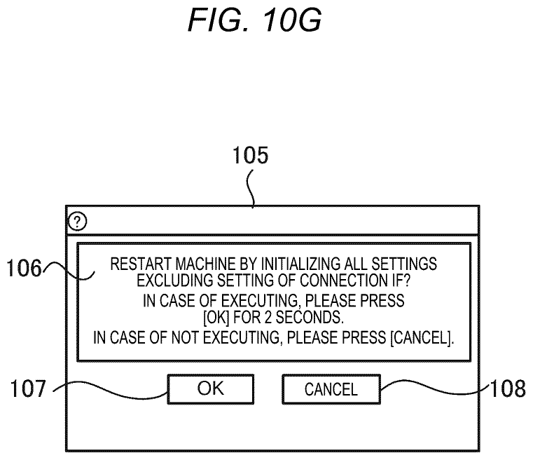

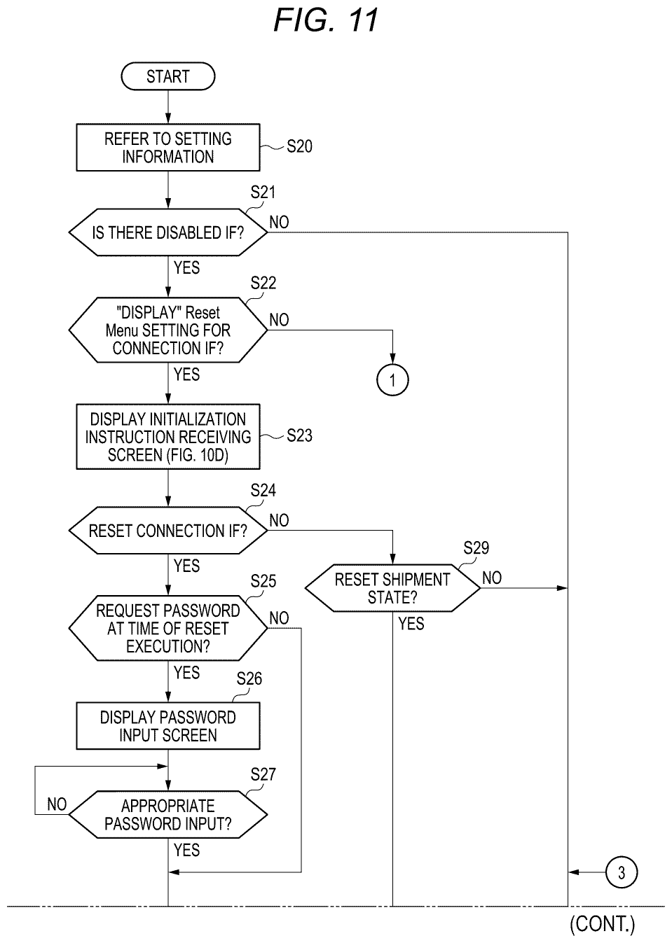

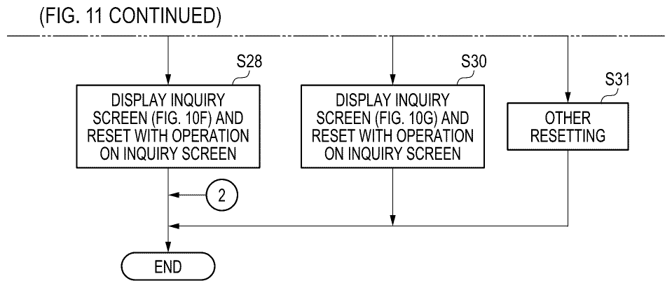

Next, a process of causing the controller 11 to execute the initialization process by operating the operation icon “all settings” 61D on the standby screen 60 will be described. In a case where the controller 11 detects that the operation icon “all settings” 61D is operated on the standby screen 60 shown in FIG. 10A, the controller 11 causes the user IF 16 to display a setting item receiving screen 80 shown in FIG. 10B. The setting item receiving screen 80 includes options 81A to 81E corresponding to items for which setting changes are to be received. Among these, the option “printer” 81A is an object that is operated when a change in a setting content of the printer 13 is received. The option “network” 81B is an object that is operated when changes in setting contents for the wireless network IF 17 and the wired network IF 18 are received. The option “report printing” 81C is an object that is operated when a change in a setting content for printing transmitted and received data history is received using the operation icon “fax” 61A of the MFP 10. The option “initial setting” 81E is an object operated when an instruction related to an initial setting for the MFP 10 is received.

In a case where the controller 11 detects that the option “initial setting” 81E shown in FIG. 10B is operated, the controller 11 causes the user IF 16 to display an initial setting item selection screen 82 shown in FIG. 10C. The initial setting item selection screen 82 includes options 83A to 83E corresponding to setting items to be selected in the initial setting. On the initial setting item selection screen 82, the option “external number” 83A is an object operated when a setting value of the external number of the transmission destination device used in the FAX transmission function is displayed. The option “reset setting” 83D is an object configured to receive an operation when various setting values stored in the memory 12 of the MFP 10 are initialized to values at the time of factory shipment. The option “reset display language” 83E is an object configured to receives an operation when a language displayed on the user IF 16 is reset.

In a case where the controller 11 detects the operation of the option “reset setting” on the initial setting item selection screen 82 shown in FIG. 10C, the controller 11 executes a suggestion screen display process shown in FIG. 11. First, the controller 11 refers to the setting information 21 stored in the memory 12 in step S20. The controller 11 determines whether there is a disabled connection IF in the setting information 21. In this example, a case will be described in which the setting information 21 is in a state shown in FIG. 7, that is, the setting values corresponding to the “wired LAN” and the “wireless LAN” in the item “IF type” are registered as “disable”. Therefore, the controller 11 determines that there is an IF type of which a setting value indicates “disable” in the setting information 21 (step S21: YES), and proceeds to step S22.

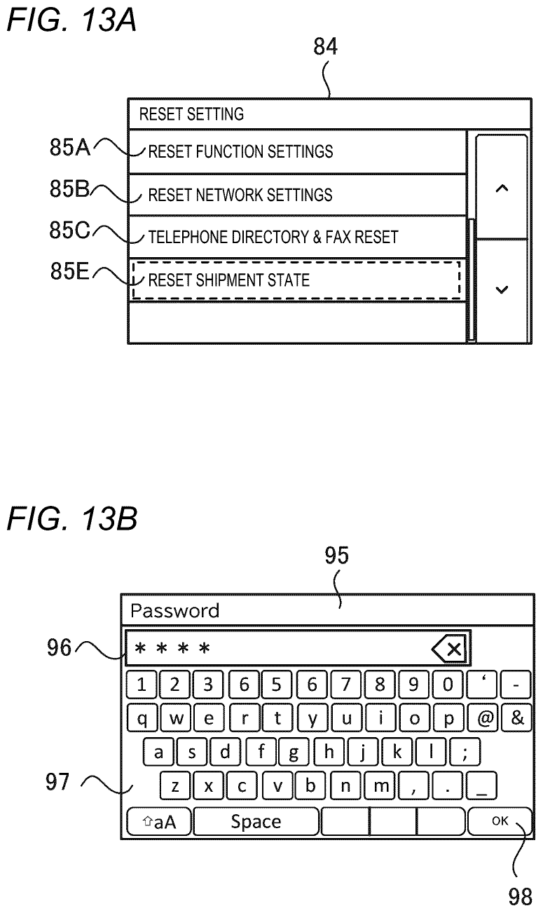

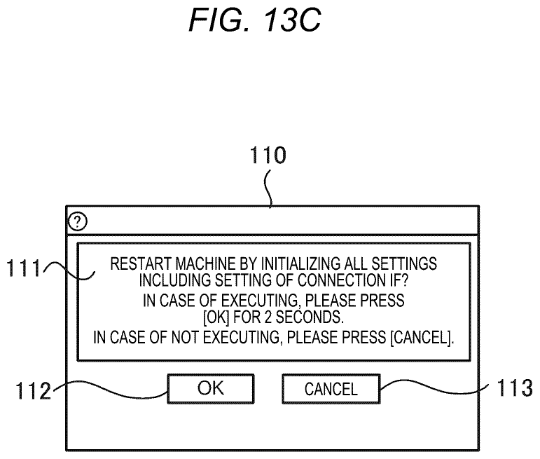

In a case where the controller 11 determines that there is no connection IF that is disabled in the setting information 21 (step S21: NO), the controller 11 proceeds to step S31. Step S31 is a step illustrating another process for the sake of convenience, and is not a step indicating a specific process. In the case of step S21: NO, the initialization instruction receiving screen 84 shown in FIG. 13A is displayed on the user IF 16 as another process. In a case where any one of the options 85A to 85E included in the initialization instruction receiving screen 84, which is an object indicating an item to be initialized, is operated, a setting value for the item to be initialized indicated by the option is reset to the shipment state. In the other process (step S31), in a case where any option is operated, an inquiry screen (not shown) for inquiring whether to initialize the target setting value may also be displayed. In this case, the inquiry screen when the option “reset shipment state” 85E is operated may not include a text that clearly indicates resetting of the setting of the connection IF. Details of FIG. 13A and the options 85A to 85E will be described later.

In step S21, the controller 11 determines whether the setting value of the item “reset menu setting for connection IF” in the display mode information 22 stored in the memory 12 is set to “display”. In a case where the setting value of the item “reset menu setting for connection IF” is set to “display”, the controller 11 proceeds to step S23.

In step S23, the controller 11 causes the user IF 16 to display the initialization instruction receiving screen 84 shown in FIG. 10D. The initialization instruction receiving screen 84 shown in FIG. 10D includes the options 85A to 85E which are objects indicating items to be initialized. Among these, the option “reset function settings” 85A is an object operated when a setting value related to a function executable by the MFP 10 among the setting values stored in the memory 12 is reset. The option “reset network settings” 85B is an object operated when a setting value related to network connection among the setting values stored in the memory 12 is reset to the shipment state. The option “reset telephone directory & fax” 85C is an object operated when information of the other party stored in a telephone directory or information of a FAX transmission destination among the setting values stored in the memory 12 is reset to the shipment state.

The option “reset connection IF settings” 85D is an object operated when a setting value related to the connection IF among the setting values stored in the memory 12 is reset to the shipment state. The option “reset shipment state” 85E is an object operated when a setting value other than the setting value related to the connection IF among the setting values stored in the memory 12 is reset to the shipment state of the MFP 10.

That is, in a case where the setting value of the item “reset menu setting for connection IF” is set to “display” in the display mode information 22, the user IF 16 displays a screen including the option “reset connection IF settings” 85D, which is an object operated when the setting value related to the connection IF is reset, as a display mode of the initialization instruction receiving screen 84. As will be described later, in a case where the setting value of the item “reset menu setting for connection IF” is set to “not display” in the display mode information 22, a screen not including the item “reset connection IF settings” 85D is displayed on the user IF 16, as the display mode of the initialization instruction receiving screen 84.

In a case where the option “reset connection IF settings” 85D is operated on the initialization instruction receiving screen 84 in step S24 (step S24: YES), the controller 11 proceeds to step S25 and determines whether the setting value of the item “password setting at time of reset execution” in the display mode information 22 is set to a value indicating that a password at the time of the reset execution is required. In a case where the setting value of the item “password setting at time of reset execution” is set to any one of the values of the “request administrator password”, “request administrator or reset password”, and “request reset password” (step S25: YES), the controller 11 proceeds to step S26 and causes the user IF 16 to display a password input screen 90 shown in FIG. 10E.

The password input screen 90 is a screen for receiving an input of an appropriate password for displaying an inquiry screen 100 to be described later. The password input screen 90 includes a password input field 91, an operation key 92, and an enter key 93. The password input in the password input field 91 is a password registered, as the setting value of the item “reset password setting”, in the display mode information 22. Specifically, in the display mode information 22, in a case where the setting value of the item “password setting at time of reset execution” is “request administrator password”, the inquiry screen 100 to be described later can be displayed by inputting the administrator password to the password input field 91. In the display mode information 22, in a case where the setting value of the item “password setting at time of reset execution” is “request administrator or reset password”, the inquiry screen 100 can be displayed by inputting either the administrator password or the reset password in the password input field 91. In the display mode information 22, in a case where the setting value of the item “password setting at time of reset execution” is “request reset password”, the inquiry screen 100 can be displayed by inputting the password, which is the setting value of the item “reset password setting”, in the password input field 91.

In a case where the user inputs an appropriate password in accordance with the setting value of the setting item “reset password setting” in the password input field 91 and operates the enter key 93 (step S27: YES), the controller 11 proceeds to step S28. In a case where the setting value of the item “password setting at time of reset execution” is the “request administrator password”, the controller 11 may display the password input screen 90 in step S26, in response to reception of an initialization instruction when the administrator has not logged in, and may receive the administrator password. In this case, in a case where the administrator has already logged in, the process may proceed to step S28 without performing the processes of step S26 and step S27.

In step S28, the controller 11 causes the user IF 16 to display the inquiry screen 100 shown in FIG. 10F. The inquiry screen 100 shown in FIG. 10F is a screen for inquiring whether to initialize the setting value of the connection IF in the setting information 21 stored in the memory 12. The inquiry screen 100 displays a permission object “OK” 102 which is an operation icon, and a text 101 that suggests restarting the MFP 10 by initializing the setting information 21 including the setting of the connection IF and that shows an operation method in that case.

In a case where the user operates the permission object “OK” 102 on the inquiry screen 100, the controller 11 initializes the setting value of the connection IF among the setting values stored in the memory 12 to a value at the time of factory shipment. In other words, in the operation on the inquiry screen 100 shown in FIG. 10F, only the setting value corresponding to the connection IF stored in the memory 12 is initialized, and the other setting values are not initialized. On the other hand, in a case where the user operates a rejection object “cancel” 103 as an operation key on the inquiry screen 100, the controller ends the process in FIG. 11 without initializing the setting values stored in the memory 12.

On the other hand, in a case where the setting value of the item “password setting at time of reset execution” of the display mode information 22 is set to a value indicating that the password at the time of the reset execution is not requested in step S25 (step S25: NO), the process proceeds to step S28, and the inquiry screen 100 shown in FIG. 10F is displayed on the user IF 16. That is, in the display mode information 22, in a case where the item “password setting at time of reset execution” is set to the value indicating that the password at the time of the reset execution is not requested, the inquiry screen 100 is displayed on the user IF 16 without displaying the password input screen 90. The process executed by the controller 11 in response to the operation on the inquiry screen 100 has already been described.

In the present embodiment, a mode in which the initialization instruction receiving screen 84 including both the option “reset connection IF settings” 85D and the option “reset shipment state” 85E is displayed in S23 after an affirmative determination is made in S22 is an example of a second mode in which a screen for receiving an initialization instruction for the first setting value stored in the memory is displayed as the suggestion screen. In this example, the initialization instruction receiving screen 84 is an example of the suggestion screen.

On the other hand, in the initialization instruction receiving screen 84 shown in FIG. 10D, in a case where the controller 11 detects that the option “reset shipment state” 85E is operated, instead of the option “reset connection IF settings” 85D (step S29: YES), the controller 11 proceeds to step S30. In step S30, the controller 11 causes the user IF 16 to display an inquiry screen 105 shown in FIG. 10G. In the present embodiment, in a case where the setting value is set to “display” in the item “reset menu setting for connection IF” in the display mode information 22, when the option “reset shipment state” 85E is operated, the inquiry screen 105 is displayed without displaying the password input screen 90, regardless of the setting value of the item “password setting at time of reset execution”.

In the inquiry screen 105 shown in FIG. 10G, a text 106 that suggests restarting the MFP 10 by initializing the setting values stored in the memory 12, excluding the setting value of the connection IF, and that shows an operation method in this case is displayed. In a case where the user operates a permission object “OK” 107 on the inquiry screen 105, the controller 11 initializes the setting values stored in the memory 12 other than the setting value corresponding to the connection IF. On the other hand, in a case where the user operates the rejection object “cancel” 108 on the inquiry screen 105, the controller 11 ends the process in FIG. 11 without initializing the setting values stored in the memory 12.

In step S30, instead of the above, in a case where the option “reset shipment state” 85E is operated (step S29: YES) and the permission object “OK” 107 is operated on the inquiry screen, the controller 11 may initialize all the setting values stored in the memory. In this case, the controller 11 may be configured to display an inquiry screen (FIG. 13C to be described later) suggesting that all the setting values including the setting value of the connection IF stored in the memory 12 be initialized to the values at the time of the factory shipment. In a case where the setting value of the item “password setting at time of reset execution” is set to the value indicating that the password at the time of the reset execution is requested in the display mode information 22, the controller 11 may make an affirmative determination in S29, cause the user IF 16 to display a screen similar to the password input screen 90 already described with reference to FIG. 10E, and receive the input of the appropriate password. In a case where the controller 11 receives the password input on the password input screen, the controller 11 proceeds to step S30 and display the inquiry screen.

On the other hand, in the initialization instruction receiving screen 84 shown in FIG. 10D, in a case where the controller 11 detects that options other than the option “reset connection IF settings” 85D and the option “reset shipment state” 85E are operated (step S29: NO), the process proceeds to step S31. In step S31, as other processes, the controller 11 resets the setting value for the item to be initialized indicated by the option to the shipment state.

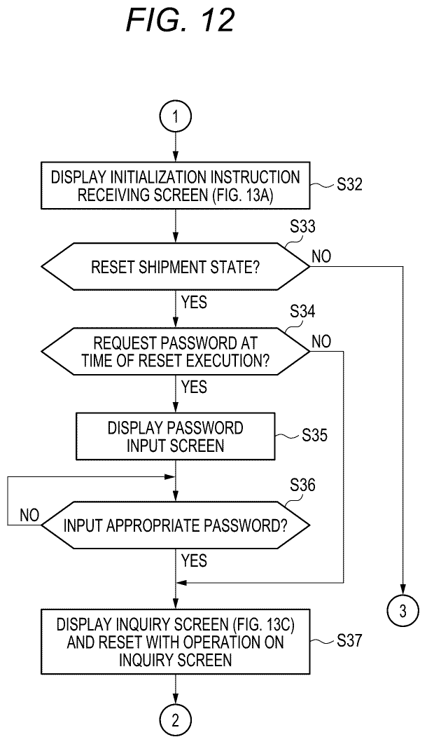

On the other hand, in the display mode information 22, in a case where the setting value of the item “reset menu setting for connection IF” is “not display” (step S22: NO), the controller 11 proceeds to step S32 in FIG. 12 and cause the user IF 16 to display the initialization instruction receiving screen 84 shown in FIG. 13A. The initialization instruction receiving screen 84 shown in FIG. 13A does not include the option “reset connection IF settings” 85D, unlike the initialization instruction receiving screen 84 shown in FIG. 10D. In this example, in a case where the initialization instruction receiving screen 84 shown in FIG. 13A is displayed on the user IF 16, the initialization of the setting value related to the connection IF and the initialization of the other setting values are performed at a time when the option “reset shipment state” 85E is operated.

In step S33, in a case where the option “reset shipment state” 85E is operated in the initialization instruction receiving screen 84 shown in FIG. 13A (step S33: YES), the controller 11 proceeds to step S34, and determines whether the setting value of the item “password setting at time of reset execution” is set to the value indicating that the password at the time of the reset execution is requested in the display mode information 22. In a case where the setting value of the item “password setting at time of reset execution” is set to the value indicating that the password at the time of the reset execution is requested (step S34: YES), the controller 11 proceeds to step S35 and cause the user IF 16 to display a password input screen 95 shown in FIG. 13B.

Similar to the password input screen 90 shown in FIG. 10E, the password input screen 95 shown in FIG. 13B is a screen for receiving an input of a password for displaying an inquiry screen 110, which will be described later. The password input screen 90 includes a password input field 91, an operation key 92, and an enter key 93. In a case where the user inputs the password corresponding to the setting value of the setting item “reset password setting” in the password input field 96 and operates the enter key 98 (step S36: YES), the controller 11 proceeds to step S37.

In step S37, the controller 11 cause the user IF 16 to display the inquiry screen 110 shown in FIG. 13C. In the inquiry screen 110 shown in FIG. 13C, a text 111 that suggests restarting the MFP 10 by initializing all the setting values including the setting value of the connection IF stored in the memory 12 to the values at the time of factory shipment and that shows an operation method in this case is displayed. That is, the inquiry screen 110 shown in FIG. 13C is a screen that suggests the user to initialize all the setting values stored in the memory 12 in a state where the setting value related to the connection IF disabled by the EWS are stored in the memory 12. Since the “all settings” include the setting value of the connection IF, the text 111 displayed on the inquiry screen 110 may not include the text “including the setting of the connection IF”.

In a case where the user operates the permission object “OK” 112 on the inquiry screen 110, the controller 11 initializes all the setting values stored in the memory 12. On the other hand, in a case where the user operates a rejection object “cancel” 113 on the inquiry screen 110, the controller ends the processes in FIGS. 11 and 12 without initializing the setting values stored in the memory 12.

On the other hand, in step S34, in a case where the item “password setting at time of reset execution” of the display mode information 22 is set to the value indicating that the password at the time of the reset execution is not requested (step S34: NO), the process proceeds to step S37, and the inquiry screen 110 shown in FIG. 13C, which has already been described, is displayed on the user IF 16. The process executed by the controller 11 in response to the operation on the inquiry screen 110 has already been described.

In the present embodiment, after a negative determination is made in step S22 and the initialization instruction receiving screen 84 not including the option “reset connection IF settings” 85D is displayed in step S32, a display mode of displaying the password input screen 95 in step S35 and a mode of displaying the inquiry screen 110 in step S37 are examples of a first mode of displaying the suggestion screen in response to reception of initialization instruction for the setting values stored in the memory. The password input screen 95 is an example of the suggestion screen. The display mode of displaying the password input screen 95 in step S35 is an example of a mode of displaying the screen for receiving the password as the suggestion screen. The mode of displaying the inquiry screen 110 in step S37 is an example of a mode of displaying a screen including a permission object as the suggestion screen.

On the other hand, in the initialization instruction receiving screen 84 shown in FIG. 13A, in a case where the controller 11 detects that options other than the option “reset shipment state” 85E is operated (step S33: NO), the controller 11 proceeds to step S31, and resets the setting value for the item to be initialized indicated by the option to the shipment state as another process.

The present embodiment described above can achieve the following effects.

In a case in which the setting information 21 indicating the disabling of the connection IF is stored in the memory 12, in a case where the initialization instruction is received, the controller 11 causes the user IF 16 to display the screen suggesting that the disabled connection IF will be enabled by the initialization. Accordingly, when the user operates the user IF 16 to initialize the setting values, the disabled connection IF will be suggested to be enabled by the initialization.

In a case where the controller 11 receives an instruction on which mode is used for displaying the screen, the controller 11 stores, in the memory 12, the setting value of the display mode information 22 indicating an instructed mode. In a case where the setting information 21 indicating the connection IF is disabled is stored in the memory 12, the controller 11 causes the user IF 16 to display the suggestion screen in a mode according to the setting value of the display mode information 22 stored in the memory 12. Accordingly, since a display mode of the suggestion screen can be set by the user, it is possible to effectively suggest that the connection IF be disabled according to the user.

A screen for receiving an instruction to disable any one of the plurality of connection IFs includes an operation object for receiving the instruction on which mode is used for displaying the suggestion screen, and the controller 11 receives the instruction on which mode is used for displaying the suggestion screen by operating the operation object, and causes the memory 12 to store the setting value of the display mode information 22, which is a value corresponding to the received instruction. Accordingly, since the user can designate the display mode of the suggestion screen by operating the operation object, operability of the user can be enhanced.

In response to the reception of the initialization instruction for the setting values stored in the memory 12, the controller 11 can receive, via the user IF 16, an instruction to display the suggestion screen in at least one of the first mode of displaying the password input screen and the second mode of displaying the initialization instruction receiving screen 84. The controller 11 stores, in the memory 12, the display mode information 22 including the setting value corresponding to the received instruction. Accordingly, the mode of the suggestion screen displayed when the setting value is initialized can be changed according to the user.

In a case where the display mode information 22 having a value indicating the first mode of displaying the password input screen is stored in the memory 12, the controller 11 causes the user IF 16 to display the password input screen, in response to the reception of the initialization instruction for the setting information 21 on the initialization instruction receiving screen 84 via the user IF 16. In a case where the password input by operating the password input screen is successfully authenticated, the controller 11 is configured to initialize the setting information 21 stored in the memory 12. Accordingly, the user needs to input the password on the password input screen, so that the user can receive the suggestion that the disabled connection IF is enabled by the initialization.

In a case where the display mode information 22 indicating the mode of displaying the password input screen is stored in the memory 12, the controller 11 displays the password input screen on the user IF 16, in response to the reception of the initialization instruction on the initialization instruction receiving screen 84, and initializes the setting information 21 stored in the memory 12 when the password input by operating the password input screen is successfully authenticated. On the other hand, in a case where the setting value of the display mode information 22, which is a value indicating a mode of displaying the inquiry screen 105 including the permission object “OK” 107, is stored in the memory 12, in response to the reception of the initialization instruction, the controller 11 cause the user IF 16 to display the inquiry screen 105 including the permission object “OK” 107, and initializes the setting information 21 stored in the memory 12 when the permission object “OK” 107 is operated. Accordingly, by inputting the password or operating the permission object “OK” 107, the user can receive the suggestion that the disabled connection IF is enabled by the initialization.

In a case where the display mode information 22 having the value indicating the first mode is stored in the memory 12, the controller 11 authenticates whether the password input to the password input screen for receiving the administrator password is the administrator password, in response to the reception of the initialization instruction, and initializes the setting information 21 stored in the memory 12 when the authentication is successful. On the other hand, in a case where the display mode information 22 having the value indicating the first mode is stored in the memory 12, the controller 11 authenticates whether the password input on the password input screen is the reset password, in response to the reception of the initialization instruction, and initializes the setting information 21 stored in the memory 12 when the authentication is successful. Accordingly, the user can select whether to use the administrator password or the reset password as the password, and can prevent a careless use of the administrator password.

In a case where the setting value of the display mode information 22, which is a value indicating the second mode, is stored in the memory 12, the controller 11 cause the user IF 16 to display the initialization instruction receiving screen 84 that is the suggestion screen including the option “reset connection IF settings” 85D. In a case where the option “reset connection IF settings” 85D is operated, the controller 11 performs a process of initializing the first setting value stored in the memory 12. In the above configuration, in a case where the user selects to display the inquiry screen 105 in the second mode, the initialization can be started by the operation for the option “reset connection IF settings” 85D in the initialization instruction receiving screen 84, and thus the initialization can be started without forcing a complicated operation.

In a case where the setting value of the display mode information 22, which is the value indicating the second mode is not stored in the memory 12, the controller 11 causes the user IF 16 to display the initialization instruction receiving screen 84 including only the option “reset shipment state” 85E as the suggestion screen. Accordingly, in a case where the setting value in the display mode information 22, which is the value indicating the second mode, is not stored in the memory 12, the user can instruct the MFP 10 to initialize all the setting values stored in the memory 12 by operating the option “reset shipment state” 85.

In a case where the setting value of the display mode information 22, which is the value indicating the second mode is stored in the memory 12, the controller 11 causes the user IF 16 to display the initialization instruction receiving screen 84 including the option “reset connection IF settings” 85D corresponding to only the initialization instruction of the first setting value stored in the setting information 21 stored in the memory 12, and the option “reset shipment state” 85E corresponding to the initialization instruction of all the setting values stored in the memory 12. On the other hand, in a case where the option “reset connection IF settings” 85D is operated, the controller 11 initializes the first setting value stored in the memory 12, and when the option “reset shipment state” 85E is operated, the controller 11 initializes setting values other than the first setting value stored in the memory 12. Accordingly, in a case where the suggestion screen is displayed in the second mode, the initialization of the first setting value and the other setting values can be separately performed, in accordance with an operation of the icon, and thus it is possible to improve convenience in initializing the setting values.

### (Modification of First Embodiment)

The MFP 10 may not include any of the connection IFs. For example, only one of the wireless network IF 17 and the wired network IF 18 may be provided as a network IF. For example, the MFP 10 may not include the communication USB IF 20. For example, the MFP 10 may not include the FAX IF 14. For example, the MFP 10 may not include the memory IF 19.

### Second Embodiment

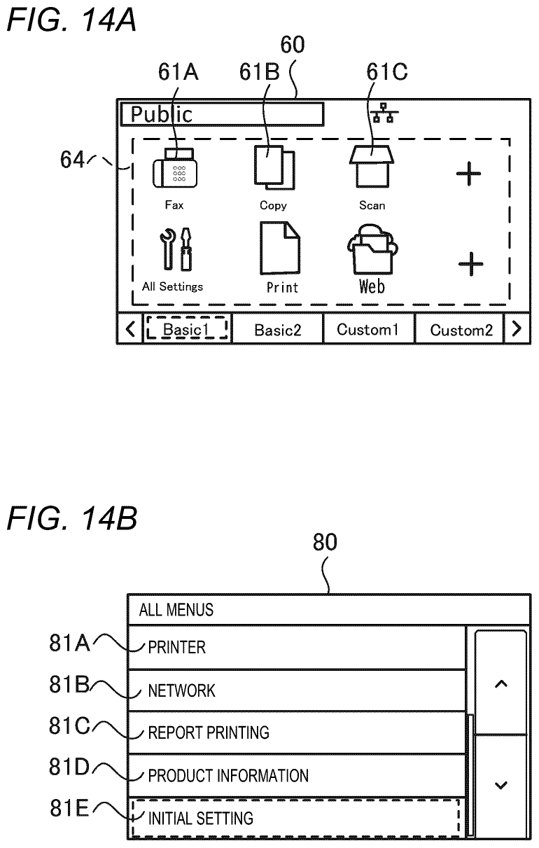

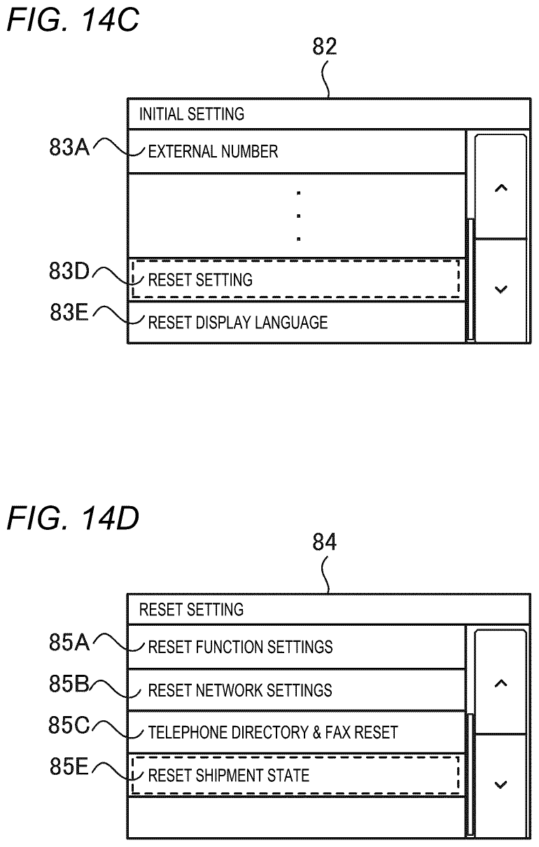

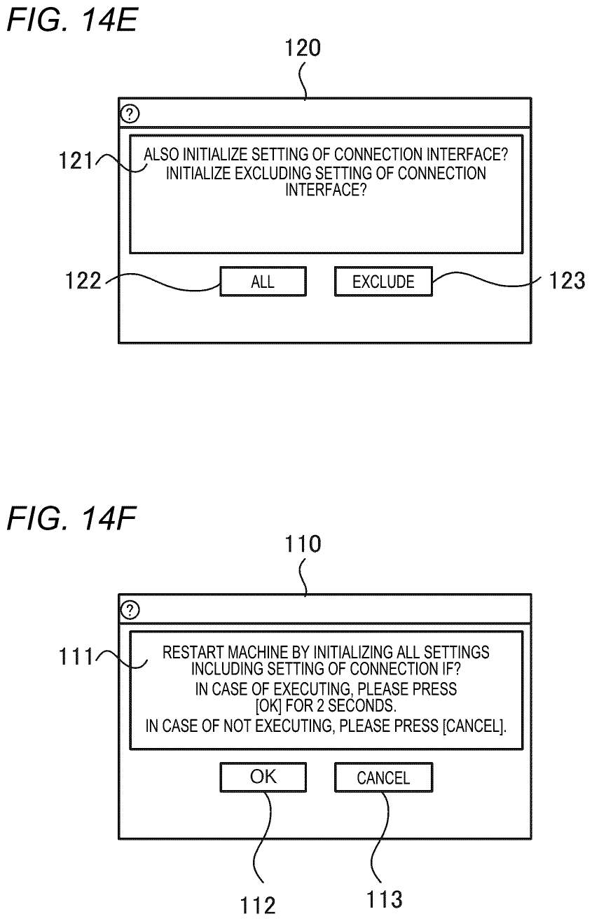

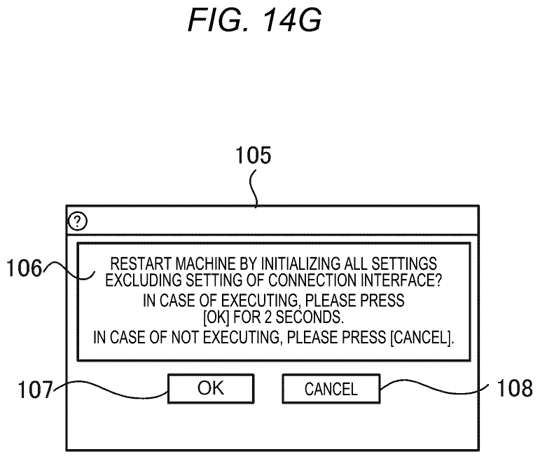

In the second embodiment, configurations different from those in the first embodiment will be mainly described. In the second embodiment, the same parts as those in the first embodiment are denoted by the same reference numerals, and description thereof will not be repeated. In the present embodiment, when the setting information 21 stored in the memory 12 indicates that any one of connection IFs is disabled, a display mode of a suggestion screen displayed on the user IF 16 is different from that in the first embodiment. FIGS. 14A to 14G shows a transition of a screen displayed on the user IF 16 of the MFP 10 in the present embodiment. Screens shown in FIGS. 14A, 14B, and 14C are the same as the screens shown in FIGS. 10A, 10B, and 10C, and a description thereof will be omitted.

In the second embodiment, in a case where there is a disabled connection IF in the setting information 21 (step S21: YES) and a setting value of the item “reset menu setting for connection IF” is set to “display” in the display mode information 22 (step S22: YES), the controller 11 proceeds to step S23. In step S23 of the second embodiment, the initialization instruction receiving screen 84 shown in FIG. 14D is displayed. Similarly to the initialization instruction receiving screen 84 shown in FIG. 13A, the initialization instruction receiving screen 84 shown in FIG. 14D does not include the option “reset connection IF settings” 85D.

In a case where the controller 11 detects that the option “reset shipment state” 85E is operated on the initialization instruction receiving screen 84 (step S29: YES), the controller 11 proceeds to step S30. In step S30 of the second embodiment, the inquiry screen 120 shown in FIG. 14E is displayed on the user IF 16. On the inquiry screen 120 shown in FIG. 14E, a text 121 that suggests that either all setting values including the setting value of the connection IF or all setting values excluding the setting value of the connection IF can be selected and initialized from among the setting values stored in the memory 12, and that shows an operation method in this case, is displayed. Further, the inquiry screen 120 includes a first permission object 122 indicating that “all” of the setting values stored in the memory 12 are initialized as a permission object, and a second permission object 123 indicating that the setting values other than the setting value of the connection IF among the setting values stored in the memory 12 are initialized.

In a case where the user operates the first permission object 122 on the inquiry screen 120, the controller 11 displays the inquiry screen 110 shown in FIG. 14F on the user IF 16. Similar to the inquiry screen 110 shown in FIG. 13C, the inquiry screen 110 shown in FIG. 14F is a screen that receives an instruction to initialize all the setting values including the setting value of the connection IF stored in the memory 12. In a case where the controller 11 detects that the permission object “OK” 112 is operated on the inquiry screen 110, the controller 11 initializes all the setting values stored in the memory 12 to values at the time of factory shipment.

On the other hand, in a case where the user operates the second permission object 123 on the inquiry screen 120, the controller 11 cause the user IF 16 to display the inquiry screen 105 shown in FIG. 14G. Similar to the inquiry screen 105 shown in FIG. 10G, the inquiry screen 105 shown in FIG. 14G is a screen that inquires the user whether to initialize the setting values other than the setting value of the connection IF stored in the memory 12. In a case where the controller 11 detects that the permission object “OK” 107 is operated on the inquiry screen 105, the controller 11 initializes the setting values other than the setting value of the connection IF among the setting values stored in the memory 12 to the values at the time of factory shipment.

In the present embodiment described above, in the case where the display mode information 22 indicating a mode of displaying an inquiry screen including the permission object is stored in the memory 12, in response to reception of an initialization instruction, the controller 11 cause the user IF 16 to display the inquiry screen 120, and in a case where the first permission object 122 indicating that all the setting information 21 including the connection IF stored in the memory 12 is initialized is operated on the inquiry screen 120, the controller 11 cause the user IF 16 to display an inquiry screen 130 for inquiring whether to initialize all the setting information 21 stored in memory. On the other hand, in a case where the second permission object 123 indicating that the setting values other than the setting value of the connection IF stored in the memory 12 are initialized is operated on the inquiry screen 120, the controller 11 cause the user IF 16 to display the inquiry screen 105 inquiring whether to initialize the setting information 21 other than the setting value 21 of the connection IF stored in the memory. Accordingly, it is possible to strongly suggest the user that setting information related on the connection IF be stored in the memory 12, and allow the user to select subsequent processes.

### (Modification of Second Embodiment)

When the controller 11 detects that the option “reset shipment state” 85E is operated on the initialization instruction receiving screen 84 (step S29: YES), the controller 11 may proceed to step S30 and cause the user IF 16 to display an inquiry screen in a following mode. For example, in step S30, the controller 11 may display an inquiry screen that suggests that initialization can be performed by selecting any one of only a setting of a connection IF and all setting values other than a setting value of the connection IF, shows an operation method, and includes corresponding permission objects. Further, in step S30, the controller 11 may display an inquiry screen that suggests that initialization can be performed by selecting any one of only the setting of the connection IF and all setting values including the setting value of the connection IF, shows an operation method, and includes corresponding permission objects. In step S30, the controller 11 may display an inquiry screen that suggests that initialization can be performed by selecting any one of only a setting of a connection IF, all the setting values other than the setting value of the connection IF, and all the setting values including the setting value of the connection IF, shows an operation method, and includes corresponding permission objects. In the modification of the second embodiment, when the permission object is selected, the controller 11 may initialize a setting value corresponding to the selected object.

### Other Embodiments

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In a case in which a setting value of the item “password setting at time of reset execution” of the display mode information 22 is registered as a value indicating that a password is not requested at the time of reset execution, the controller 11 may reset a setting value targeted by an option without displaying an inquiry screen even when any one of the options 85A to 85E of the initialization instruction receiving screen 84 is selected in step S28.

In an embodiment, when the option “reset setting” 83D is operated on the initial setting item selection screen 82, the controller 11 may display an inquiry screen including objects corresponding to all or some of the options 85A to 85E without displaying the initialization instruction receiving screen 84, and when any one of the objects is selected, the setting value targeted by the selected option may be reset. When an object corresponding to the option 85E is selected, input of an appropriate password may be requested according to the setting value of the item “password setting at time of reset execution” of the display mode information 22.

The MFP 10 may receive a request from the browser 201 via the wireless network IF 17 or a connection IF other than the wired network IF 18 and provide the Web page data to the browser 201. For example, the MFP 10 may receive an HTTPS request from the browser 201 via a USB IF and send the Web page data back to the browser 201. In this case, an IF for receiving the request from the browser 201 is an example of the connection IF. Further, the IF for providing the Web page data is an example of the connection IF.

In the above-described embodiment, the controller 11 causes the browser 201 of the PC 200 to display a Web page by a remote process, and receives a designation operation of enabling and disabling the connection IF from an administrator. Instead of this, the controller 11 may cause the user IF 16 to display a screen for receiving the designation operation of enabling and disabling the connection IF, and may receive the designation operation of enabling and disabling the connection IF in response to an operation on the screen. In this case, the controller 11 also can receive the designation of enabling and disabling the connection IF on a condition that the administrator has logged in. In this case, when the enabling and disabling of the connection IF is designated by an operation on the user IF 16, the controller 11 may set an item of the setting information 21 to a value indicating a state of enabling by a EWS or a state of disabling by the EWS by the processes in S13 and S16 shown in FIG. 6.

The printing apparatus is not limited to the MFP 10, and may be an apparatus including only the printer 13.

What is claimed is:

1. A printing apparatus comprising:
a plurality of connection interfaces;
a user interface;
a printer;
a memory; and
a controller,
wherein the printing apparatus has at least one of:
a function of acquiring image data from an external device via any one of the plurality of connection interfaces, and of causing the printer to print the image data;
a function of providing the external device with data via any one of the plurality of connection interfaces; and
a function of acquiring an instruction from the external device via any one of the plurality of connection interfaces, and of performing a process according to the acquired instruction, and
the controller is configured to:
disable a connection interface among the plurality of connection interfaces, a first setting value stored in the memory indicating the connection interface is disabled; and
perform:
an initialization process of initializing a setting value stored in the memory, according to an initialization instruction corresponding to an operation on the user interface; and
in a case where the controller receives a disabling instruction designating any one of the plurality of connection interfaces, a disabling process of storing, in the memory, the first setting value having a value indicating the designated connection interface is disabled,
in a case where the first setting value indicating the connection interface is disabled is stored in the memory and the controller received the initialization instruction, perform a suggestion screen display process of causing the user interface to display a suggestion screen for suggesting that the first setting value stored in the memory is initialized to an initial value of the first setting value, the initial value of the first setting value being a value indicating the connection interface is enabled.

2. The printing apparatus according to claim 1,
wherein, in the disabling process, the controller is configured not to:
in a case where the first setting value indicates a connection interface for USB communication with the external device is disabled, perform a process used in a function of receiving the image data from the external device via the USB communication and of printing the image data,
in a case where the first setting value indicates a connection interface for connecting to a USB memory is disabled, perform a process used in a function of acquiring the image data from the connected USB memory and of printing the image data, and
in a case where the first setting value indicates a connection interface for LAN communication with the external device is disabled, perform a process used in a function of receiving the image data from the external device via the LAN communication and of printing the image data.

3. The printing apparatus according to claim 1,
wherein, in a case where the instruction on which mode is used for displaying the suggestion screen, the controller is configured to store, in the memory, a second setting value indicating the instructed mode, and
in the suggestion screen display process, in a case where the first setting value indicating the connection interface is disabled is stored in the memory, the controller is configured to cause the user interface to display the suggestion screen in a mode according to a value of the second setting value stored in the memory.

4. The printing apparatus according to claim 3,
wherein the controller is configured to:
in a case where the controller receives an instruction to disable any one of the plurality of connection interfaces, receive the instruction on which mode is used for displaying the suggestion screen, and
store, in the memory, the first setting value and the second setting value corresponding to the received instructions.

5. The printing apparatus according to claim 4,
wherein a screen for receiving the instruction to disable any one of the plurality of connection interfaces includes an operation object configured to receive the instruction on which mode is used for displaying the suggestion screen, and
the controller is configured to:
receive the instruction on which mode is used for displaying the suggestion screen, according to an operation on the operation object; and
store, in the memory, the second setting value which corresponding to the received instruction.

6. The printing apparatus according to claim 3,
wherein the controller is configured to:
receive, via the user interface, an instruction to display the suggestion screen in at least one mode of:
a first mode in which the suggestion screen is displayed in response to reception of the initialization instruction for the setting value stored in the memory; and
a second mode in which a screen for receiving the initialization instruction for the first setting value stored in the memory is displayed as the suggestion screen, and
store, in the memory, the second setting value corresponding to the received instruction.

7. The printing apparatus according to claim 6,
wherein, in the suggestion screen display process, the controller is configured to:
in a case where the second setting value indicating the first mode is stored in the memory, cause the user interface to display, as the suggestion screen, a screen for receiving a password, in response to the reception of the initialization instruction for the setting value stored in the memory via the user interface, and
in a case where a password input by an operation on the screen for receiving the password is successfully authenticated, initialize the first setting value stored in the memory.

8. The printing apparatus according to claim 7,
wherein the controller is configured to:
receive, as the first mode, from an administrator, an instruction of any one of a mode in which the screen for receiving the password is displayed as the suggestion screen, and a mode in which the screen for receiving the password is not displayed and a screen including a permission object is displayed as the suggestion screen, the permission object being an operation object corresponding to permission of the initialization of the first setting value; and
store, in the memory, the second setting value indicating the received mode, in the suggestion screen display process, the controller is configured to:
in a case where the second setting value indicating the mode, as the first mode, in which the screen for receiving the password is displayed as the suggestion screen is stored in the memory, cause the user interface to display the screen for receiving the password, in response to the reception of the initialization instruction; and
in a case where the password input by the operation of the screen for receiving the password is successfully authenticated, initialize the first setting value stored in the memory, and
in the suggestion screen display process, the controller is configured to:
in a case where the second setting value indicating the mode, as the first mode, in which the screen including the permission object is displayed as the suggestion screen is stored in the memory, cause the user interface to display the screen including the permission object, as the suggestion screen, in response to the reception of the initialization instruction; and
in a case where the permission object is operated, initialize the first setting value stored in the memory.

9. The printing apparatus according to claim 8,
wherein the controller is configured to:
receive an instruction of any one of a mode in which a screen for receiving an administrator password is displayed as the suggestion screen, and a mode in which a screen for receiving a reset password is displayed as the suggestion screen as the mode in which the screen for receiving the password is displayed as the suggestion screen; and
store the second setting value which is a value indicating the received mode in the memory,
in the suggestion screen display process, the controller is configured to:
in a case where the second setting value indicating the mode, as the first mode, in which the screen for receiving the administrator password is displayed as the suggestion screen is stored in the memory, cause the user interface to display the screen for receiving the administrator password, in response to the reception of the initialization instruction; and
authenticate whether a password input by an operation via the screen for receiving the administrator password is the administrator password, and in a case where the authentication is successful, initialize the first setting value stored in the memory, and
in the suggestion screen display process, the controller is configured to:
in a case where the second setting value indicating the mode, as the first mode, in which the screen for receiving the reset password is displayed as the suggestion screen is stored in the memory, cause the user interface to display the screen for receiving the reset password, in response to the reception of the initialization instruction; and
authenticate whether a password input by an operation via the screen for receiving the reset password is the reset password, and in a case where the authentication is successful, initialize the first setting value stored in the memory.

10. The printing apparatus according to claim 9,
wherein the administrator password is a password necessary for the administrator to log-in the printing apparatus, the reset password is not a password necessary for the administrator to log-in the printing apparatus, and
in the suggestion screen display process, the controller is configured to:
in a case where the administrator has not logged in in the case in which the second setting value which is the value indicating the mode, as the first mode, in which the screen for receiving the administrator password is displayed as the suggestion screen is stored in the memory, cause the user interface to display the screen for receiving the administrator password, in response to the reception of the initialization instruction.

11. The printing apparatus according to claim 9,
wherein the administrator password is a password necessary for the administrator to perform, on the printing apparatus, an operation that is permitted to the administrator and that is not permitted to a user other than the administrator, and
the reset password is not a password necessary for performing an operation that is not permitted to the user other than the administrator.

12. The printing apparatus according to claim 9,
wherein the controller is configured to:
in a case where the instruction to disable any one of the plurality of connection interfaces is received from the administrator, receive designation of the reset password;
in a case where the second setting value indicating the mode, as the first mode, in which the screen for receiving the reset password is displayed as the suggestion screen is stored in the memory, cause the user interface to display the screen for receiving the reset password, in response to the reception of the initialization instruction via the user interface; and
authenticate whether the password input through the operation via the screen for receiving the reset password is the reset password designated by the administrator, and in a case where the authentication is successful, initialize the first setting value stored in the memory.

13. The printing apparatus according to claim 6,
wherein in the suggestion screen display process, the controller is configured to:
in a case where the second setting value which is a value indicating the second mode is stored in the memory, cause the user interface to display the screen for receiving the initialization instruction via the user interface as the suggestion screen, the screen including an operation object corresponding to the initialization of the first setting value stored in the memory; and
in a case where the operation object is operated, initialize the first setting value stored in the memory.

14. The printing apparatus according to claim 13,
wherein in the suggestion screen display process, the controller is configured to:
in a case where the second setting value indicating the second mode is not stored in the memory, cause the user interface to display, as the suggestion screen, the screen for receiving the initialization instruction for the first setting value stored in the memory and a setting value other than the first setting value.

15. The printing apparatus according to claim 13,
wherein in the suggestion screen display process, the controller is configured to:
in a case where the second setting value indicating the second mode is stored in the memory, cause the user interface to display the screen for receiving the initialization instruction as the suggestion screen, the screen including an icon corresponding only to the initialization instruction of the first setting value stored in the memory and an icon corresponding to the initialization instruction of the setting value stored in the memory;
in a case where the icon corresponding only to the initialization instruction of the first setting value stored in the memory is operated, initialize the first setting value stored in the memory; and
in a case where the icon corresponding to the initialization instruction of the setting value stored in the memory is operated, initialize a setting value other than the first setting value stored in the memory.

16. The printing apparatus according to claim 13,
wherein in the suggestion screen display process, the controller is configured to:
in a case where the second setting value indicating the second mode is stored in the memory, cause the user interface to display the screen for receiving the initialization instruction as the suggestion screen, the screen including an icon corresponding only to the initialization instruction of the first setting value stored in the memory and an icon corresponding to the initialization instruction of the setting value stored in the memory;
in a case where the icon corresponding only to the initialization instruction of the first setting value stored in the memory is operated, initialize the first setting value stored in the memory; and
in a case where the icon corresponding to the initialization instruction of the setting value stored in the memory is operated, initialize all setting values including the first setting value stored in the memory.

17. The printing apparatus according to claim 13,
wherein in the suggestion screen display process, in a case where second setting values which are a value indicating the first mode and the value indicating the second mode are stored in the memory, the controller is configured to:
in a case where the first setting value indicating the connection interface is disabled is stored in the memory, cause the user interface to display the screen for receiving the initialization instruction, the screen including the operation object corresponding to the initialization of the first setting value stored in the memory,
display a screen for receiving a password on the user interface as the suggestion screen, in response to the operation of the operation object, and
in a case where a password input by an operation of the screen for receiving the password is successfully authenticated, initialize the first setting value stored in the memory.

18. The printing apparatus according to claim 8,
wherein in the suggestion screen display process, the controller is configured to:
in a case where the second setting value indicating the mode, as the first mode, in which the screen including the permission object is displayed as the suggestion screen is stored in the memory, cause the user interface to display the screen including the permission object which is the operation object indicating that the setting value stored in the memory is initialized, in response to the reception of the initialization instruction; and
in a case where the permission object is operated on the screen, cause the user interface to display a screen for inquiring whether to initialize the first setting value stored in the memory.

19. The printing apparatus according to claim 1,
wherein in a case where an instruction on which mode is used for displaying the suggestion screen is received, the controller is configured to store, in the memory, a second setting value indicating an instructed mode, and
in the suggestion screen display process, the controller is configured to:
in a case where the second setting value indicating a first mode of displaying the suggestion screen is stored in the memory, cause the user interface to display a screen for receiving a password as the suggestion screen, in response to the reception of the initialization instruction for the setting value stored in the memory, and
in a case where a password input by an operation of the screen for receiving the password is successfully authenticated, initialize the first setting value stored in the memory.

20. The printing apparatus according to claim 19,
wherein in the suggestion screen display process, in a case where the second setting value indicating a mode, as the first mode, in which a screen for receiving an administrator password is displayed as the suggestion screen is stored in the memory, the controller is configured to:
display the screen for receiving the administrator password on the user interface, in response to the reception of the initialization instruction;
authenticate whether a password input by an operation via the screen for receiving the administrator password is the administrator password, and in a case where the authentication is successful, initialize the first setting value stored in the memory; and
in a case where an administrator is not logged in, cause the user interface to display the screen for receiving the administrator password, in response to the reception of the initialization instruction,
in the suggestion screen display process, the controller is configured to:
in a case where the second setting value indicating a mode, as the first mode, in which a screen for receiving a reset password is displayed as the suggestion screen is stored in the memory, cause the user interface to display the screen for receiving the reset password, in response to the reception of the initialization instruction;
authenticate whether a password input by an operation via the screen for receiving the reset password is the reset password, and in a case where the authentication is successful, initialize the first setting value stored in the memory, and
the administrator password is a password necessary for the administrator to log-in to the printing apparatus, and the reset password is not the password necessary for the administrator to log-in to the printing apparatus.

21. The printing apparatus according to claim 19,
wherein in the suggestion screen display process, in the case where the second setting value indicating a mode, as the first mode, in which a screen for receiving an administrator password is displayed as the suggestion screen is stored in the memory, the controller is configured to:
display the screen for receiving the administrator password on the user interface, in response to the reception of the initialization instruction,
authenticate whether a password input by an operation via the screen for receiving the administrator password is the administrator password, and in a case where the authentication is successful, initialize the first setting value stored in the memory; and
in a case where an administrator is not logged in, cause the user interface to display the screen for receiving the administrator password, in response to the reception of the initialization instruction,
in the suggestion screen display process, the controller is configured to:
in a case where the second setting value indicating a mode, as the first mode, in which a screen for receiving a reset password is displayed as the suggestion screen is stored in the memory, cause the user interface to display the screen for receiving the reset password, in response to the reception of the initialization instruction;
authenticate whether a password input by an operation via the screen for receiving the reset password is the reset password, and in a case where the authentication is successful, initialize the first setting value stored in the memory, and
the administrator password is a password necessary for the administrator to perform, on the printing apparatus, an operation that is permitted to the administrator and that is not permitted to a user other than the administrator, and the reset password is not a password necessary for performing an operation that is not permitted to the user other than the administrator.

22. The printing apparatus according to claim 19,
wherein in a case where the instruction to disable any one of the plurality of connection interfaces is received from an administrator, the controller is configured to receive designation of a reset password, and
in the suggestion screen display process, the controller is configured to:
in a case where the second setting value indicating a mode, as the first mode, in which a screen for receiving an administrator password is displayed as the suggestion screen is stored in the memory, cause the user interface to display the screen for receiving the administrator password, in response to the reception of the initialization instruction;
authenticate whether a password input by an operation via the screen for receiving the administrator password is the administrator password, and in a case where the authentication is successful, initialize the first setting value stored in the memory;
in a case where the second setting value indicating a mode, as the first mode, in which a screen for receiving the reset password is displayed as the suggestion screen is stored in the memory, cause the user interface to display the screen for receiving the reset password, in response to the reception of the initialization instruction; and
authenticate whether a password input by an operation via the screen for receiving the reset password is the reset password designated by the administrator, and in a case where the authentication is successful, initialize the first setting value stored in the memory.

23. The printing apparatus according to claim 1,
wherein in a case where an instruction on which mode is used for displaying the suggestion screen is received, the controller is configured to store a second setting value indicating an instructed mode in the memory, and
in the suggestion screen display process, the controller is configured to:
in a case where the second setting value indicating a second mode in which a screen for receiving the initialization instruction for the first setting value stored in the memory is displayed as the suggestion screen is stored in the memory, cause the user interface to display the screen for receiving the initialization instruction via the user interface as the suggestion screen, the screen including an operation object corresponding to the initialization of the first setting value stored in the memory, and
in a case where the operation object is operated, initialize the first setting value stored in the memory.
